(19) United States
(12) Patent Application Publication
(10) Pub. No.: US 2014/0086479 A1
(43) Pub. Date: Mar. 27, 2014

(54) SIGNAL PROCESSING APPARATUS, SIGNAL PROCESSING METHOD, OUTPUT APPARATUS, OUTPUT METHOD, AND PROGRAM

(71) Applicant: SONY CORPORATION, Tokyo (JP)

(72) Inventors: Jun LUO, Tokyo (JP); Liqing ZHANG, Shanghai (CN); Haohua ZHAO, Shanghai (CN); Weizhi XU, Shanghai (CN); Zhenbang SUN, Shanghai (CN); Wei SHI, Shanghai (CN); Takefumi NAGUMO, Kanagawa (JP)

(73) Assignee: SONY CORPORATION, Tokyo (JP)

(21) Appl. No.: 14/022,606

(22) Filed: Sep. 10, 2013

(30) Foreign Application Priority Data
Sep. 21, 2012 (JP) 2012208320

(51) Int. Cl. G06K 9/66

(52) U.S. Cl. CPC G06K 9/66
USPC 382/156

(57) ABSTRACT

There is provided a signal processing apparatus including a learning unit that learns a plurality of base signals of which coefficients become sparse, using a cost function including a term showing a correspondence between the coefficients, such that signals are represented by a linear operation of the plurality of base signals.

### BACKGROUND

The present disclosure relates to a signal processing apparatus, a signal processing method, an output apparatus, an output method, and a program and particularly, to a signal processing apparatus, a signal processing method, an output apparatus, an output method, and a program that enable an accurate base signal to be obtained.

Recently, various image restoration technologies using sparse coding have been studied. The sparse coding is a method of modeling a human visual system, decomposing a signal into base signals, and representing the signal.

Specifically, in the human visual system, an image that is captured by a retina is not transmitted to an upper recognition mechanism as it is and is decomposed into a linear sum of a plurality of base images as represented by the following expression 1 and is transmitted, at a stage of an early vision.

(Image)=Σ[(Coefficient)×(Base Image)] (1)

In the expression 1, a large number of coefficients become 0 and only a small number of coefficients become large values. That is, the coefficients become sparse. For this reason, the method of modeling the human visual system, decomposing the signal into the base signals, and representing the signal is called the sparse coding.

In the sparse coding, first, the base signal that is modeled by the above expression 1 is learned using a cost function represented by the following expression 2. In this case, it is assumed that a signal becoming a sparse coding object is an image.

L=argmin{∥Dα−Y∥²+μ∥α∥₀} (2)

In the expression 2, L denotes a cost function and D denotes a matrix (hereinafter, referred to as a base image matrix) in which an arrangement of pixel values of individual pixels of base images in a column direction is arranged in a row direction for every base image. In addition, α denotes a vector (hereinafter, referred to as a base image coefficient vector) in which coefficients of the individual base images (hereinafter, referred to as base image coefficients) are arranged in the column direction and Y denotes a vector (hereinafter, referred to as a learning image vector) in which pixel values of individual pixels of learning images are arranged in the column direction. In addition, μ denotes a previously set parameter.

Next, in the expression 2, a base image coefficient when the cost function calculated using the learned base image and the sparse coding object image, instead of the learning image, becomes a predetermined value or less, is calculated.

Recently, a method of dividing the sparse coding object image into blocks and calculating base image coefficients in units of the blocks has been devised (for example, refer to Michal Aharon, Michael Elad, and Alred Bruckstein, “K-SVD: An Algorithm for Designing Overcomplete Dictionaries for Sparse Representation”, IEEE TRANSACTION ON SIGNAL PROCESSING, VOL. 54, No. 11, NOVEMBER 2006, P4311-4322).

As restrictions for the base image coefficient in the cost function, in addition to an L0 norm represented by the expression 2, an L1 norm or an approximate expression of the L1 norm exists (for example, refer to Libo Ma and Liqing Zhang, “Overcomplete topographic independent component analysis”, Neurocomputing, 10 Mar. 2008, P2217-2223). When the base image coefficient is restricted by the L1 norm, the cost function is represented by the following expression 3 and when the base image coefficient is restricted by the approximate expression of the L1 norm, the cost function is represented by the following expression 4.

L=argmin{∥Dα−Y∥²+μ∥α∥₁} (3)

L=argmin{∥Dα−Y∥²+μF(α^{T}α)}

F(y)=a\sqrt{y}+b (4)

In the expressions 3 and 4, L denotes a cost function, D denotes a base image matrix, α denotes a base image coefficient vector, Y denotes a learning image vector, and μ denotes a previously set parameter. In the expression 4, a, y, and b denote previously set parameters.

Meanwhile, a most important element of the sparse coding is learning of the base signals. In the related art, the base signals are learned on the assumption that the base signals have redundancy and randomness (there is no correlation between the base signals).

### SUMMARY

However, recently, it has been known that ignition of a neuron is not generated randomly and has a correlation with ignition of surrounding neurons (a topographic structure), from the latest study on the human visual system. Therefore, when the base signals are learned on the assumption that there is no correlation between the base signals as in the related art, accurate base signals may not be learned.

It is desirable to enable an accurate base signal to be obtained.

According to a first embodiment of the present technology, there is provided a signal processing apparatus including a learning unit that learns a plurality of base signals of which coefficients become sparse, using a cost function including a term showing a correspondence between the coefficients, such that signals are represented by a linear operation of the plurality of base signals.

A signal processing method and a program according to the first embodiment of the present disclosure correspond to the signal processing apparatus according to the embodiment of the present disclosure.

According to the first embodiment of the present technology, there is provided a signal processing method performed by a signal processing apparatus, the signal processing method including learning a plurality of base signals of which coefficients become sparse, using a cost function including a term showing a correspondence between the coefficients, such that signals are represented by a linear operation of the plurality of base signals.

According to a second embodiment of the present technology, there is provided an output apparatus including an operation unit that operates coefficients of predetermined signals, based on a plurality of base signals of which coefficients become sparse, learned using a cost function including a term showing a correspondence between the coefficients, such that signals are represented by a linear operation of the plurality of base signals, the predetermined signals, and the cost function.

An output method and a program according to the second embodiment of the present disclosure correspond to the output apparatus according to another embodiment of the present disclosure.

According to the second embodiment of the present technology, there is provided an output method performed by an output apparatus, the output method including operating coefficients of predetermined signals, based on a plurality of base signals of which coefficients become sparse, learned using a cost function including a term showing a correspondence between the coefficients, such that signals are represented by a linear operation of the plurality of base signals, the predetermined signals, and the cost function.

The signal processing apparatus according to the first embodiment and the output apparatus according to the second embodiment may be independent apparatuses or may be internal blocks constituting one apparatus.

According to the first embodiment of the present disclosure described above, accurate base signals can be learned.

According to the second embodiment of the present disclosure described above, the accurately learned base signals can be obtained and coefficients of the base signals can be operated.

### BRIEF DESCRIPTION OF THE DRAWINGS

FIG. 1 is a diagram illustrating an outline of image restoration using sparse coding;

FIG. 2 is a block diagram illustrating a configuration example of a learning apparatus that corresponds to a first embodiment of a signal processing apparatus to which the present disclosure is applied;

FIG. 3 is a diagram illustrating a first example of blocks divided by a dividing unit of FIG. 2;

FIG. 4 is a diagram illustrating a second example of blocks divided by the dividing unit of FIG. 2;

FIG. 5 is a diagram illustrating a background of learning in a learning unit of FIG. 2;

FIG. 6 is a diagram illustrating a restriction condition when learning is performed by the learning unit of FIG. 2;

FIG. 7 is a flowchart illustrating learning processing of the learning apparatus of FIG. 2;

FIG. 8 is a block diagram illustrating a first configuration example of an image generating apparatus that corresponds to a first embodiment of an output apparatus to which the present disclosure is applied;

FIG. 9 is a diagram illustrating processing of a generating unit of FIG. 8;

FIG. 10 is a flowchart illustrating generation processing of the image generating apparatus of FIG. 8;

FIG. 11 is a block diagram illustrating a second configuration example of an image generating apparatus that corresponds to the first embodiment of the output apparatus to which the present disclosure is applied;

FIG. 12 is a flowchart illustrating generation processing of the image generating apparatus of FIG. 11;

FIG. 13 is a block diagram illustrating a configuration example of a learning apparatus that corresponds to a second embodiment of the signal processing apparatus to which the present disclosure is applied;

FIG. 14 is a diagram illustrating a restriction condition when learning is performed by a learning unit of FIG. 13;

FIG. 15 is a flowchart illustrating learning processing of the learning apparatus of FIG. 13;

FIG. 16 is a block diagram illustrating a configuration example of an image generating apparatus that corresponds to a second embodiment of the output apparatus to which the present disclosure is applied;

FIG. 17 is a flowchart illustrating generation processing of the image generating apparatus of FIG. 16;

FIG. 18 is a block diagram illustrating a configuration example of a learning apparatus that corresponds to a third embodiment of the signal processing apparatus to which the present disclosure is applied;

FIG. 19 is a block diagram illustrating a configuration example of a band dividing unit of FIG. 18;

FIG. 20 is a diagram illustrating a restriction condition when learning is performed by a learning unit of FIG. 18;

FIG. 21 is a flowchart illustrating learning processing of the learning apparatus of FIG. 18;

FIG. 22 is a block diagram illustrating a configuration example of an image generating apparatus that corresponds to a third embodiment of the output apparatus to which the present disclosure is applied;

FIG. 23 is a block diagram illustrating a configuration example of a generating unit of FIG. 22;

FIG. 24 is a flowchart illustrating generation processing of the image generating apparatus of FIG. 22;

FIG. 25 is a block diagram illustrating a configuration example of a learning apparatus that corresponds to a fourth embodiment of the signal processing apparatus to which the present disclosure is applied;

FIG. 26 is a diagram illustrating a restriction condition when learning is performed by a learning unit of FIG. 25;

FIG. 27 is a block diagram illustrating a configuration example of an image generating apparatus that corresponds to a fourth embodiment of the output apparatus to which the present disclosure is applied;

FIG. 28 is a block diagram illustrating a configuration example of a learning apparatus that corresponds to a fifth embodiment of the signal processing apparatus to which the present disclosure is applied;

FIG. 29 is a block diagram illustrating a configuration example of an audio generating apparatus that corresponds to a fifth embodiment of the output apparatus to which the present disclosure is applied;

FIG. 30 is a block diagram illustrating a configuration example of a learning apparatus that corresponds to a sixth embodiment of the signal processing apparatus to which the present disclosure is applied;

FIG. 31 is a flowchart illustrating learning processing of the learning apparatus of FIG. 30;

FIG. 32 is a block diagram illustrating a configuration example of an abnormality detecting apparatus that corresponds to a sixth embodiment of the output apparatus to which the present disclosure is applied;

FIG. 33 is a diagram illustrating an example of a detection region that is extracted by an extracting unit of FIG. 32;

FIG. 34 is a diagram illustrating a method of generating abnormality information by a recognizing unit of FIG. 32;

FIG. 35 is a flowchart illustrating abnormality detection processing of the abnormality detecting apparatus of FIG. 32; and

FIG. 36 is a block diagram illustrating a configuration example of hardware of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Outline of Image Restoration Using Sparse Coding

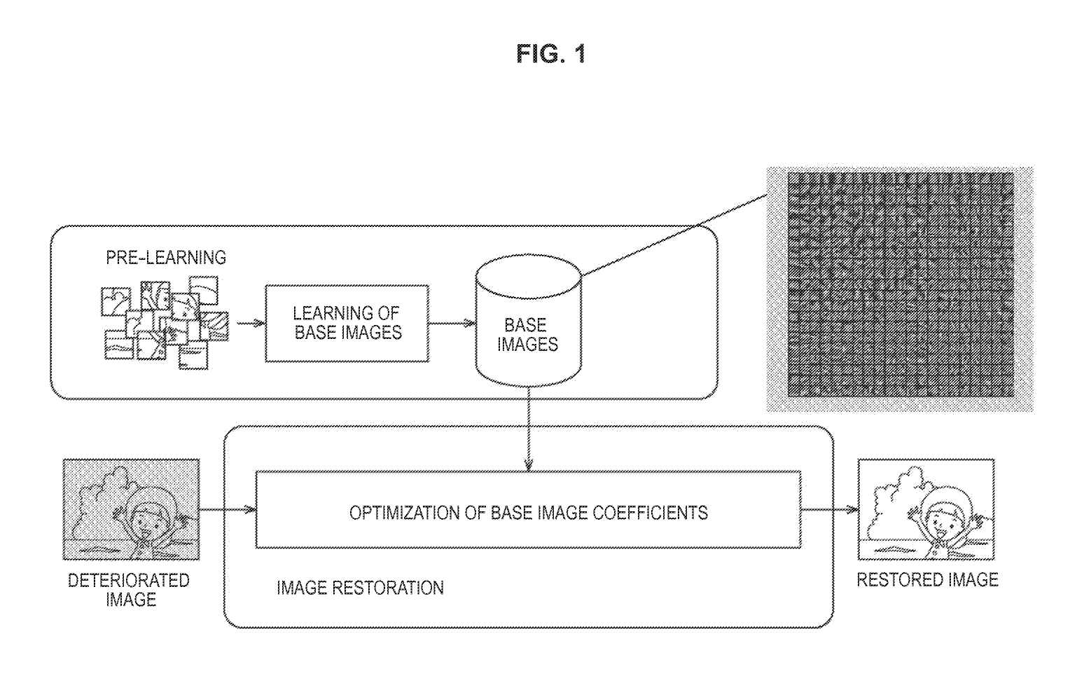

FIG. 1 is a diagram illustrating an outline of image restoration using sparse coding.

As illustrated in FIG. 1, in the image restoration using the sparse coding, base images are previously learned using a large amount of learning images not having image quality deterioration and the base images obtained as a result are held. In addition, optimization of base image coefficients is performed with respect to a deteriorated image in which image quality is deteriorated and which is input as an object of the sparse coding, using the base images, and an image not having image quality deterioration that corresponds to the deteriorated image is generated as a restored image, using the optimized base image coefficients and the base images.

### Configuration Example of Learning Apparatus

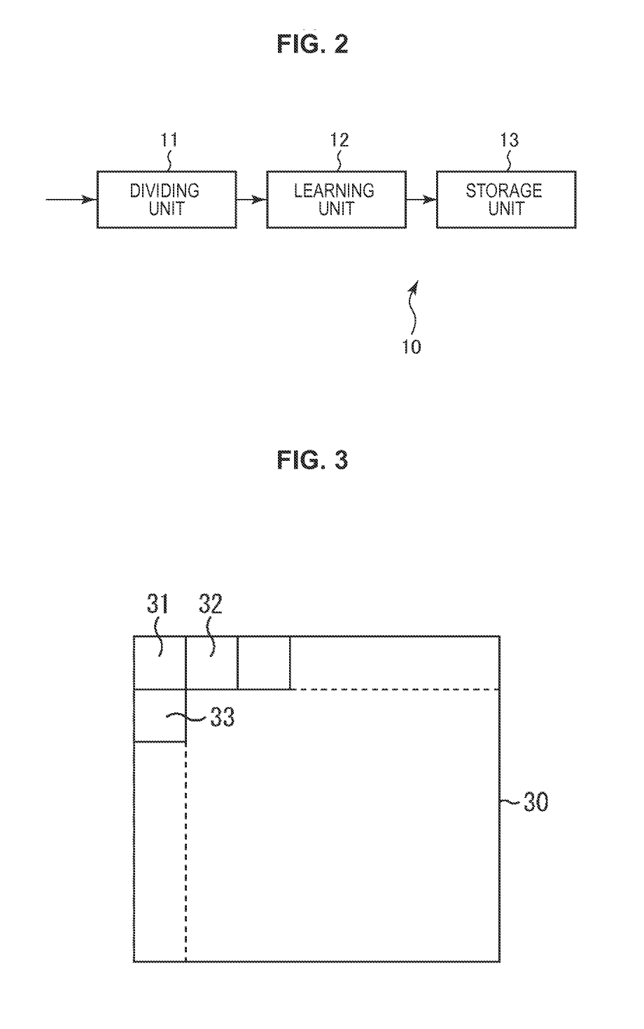

FIG. 2 is a block diagram illustrating a configuration example of a learning apparatus that corresponds to a first embodiment of a signal processing apparatus to which the present disclosure is applied.

As illustrated in FIG. 2, a learning apparatus 10 includes a dividing unit 11, a learning unit 12, and a storage unit 13 and learns base images of the sparse coding for the image restoration.

Specifically, still images of a large amount of learning brightness images that do not have image quality deterioration are input from the outside to the dividing unit 11 of the learning apparatus 10. The dividing unit 11 divides the still image of the learning brightness image into blocks having predetermined sizes (for example, 8×8 pixels) and supplies the blocks to the learning unit 12.

The learning unit 12 models the blocks supplied from the dividing unit 11 by the expression 1 described above and learns base images of block units, under a restriction condition in which there is a spatial correspondence between the base image coefficients. Specifically, the learning unit 12 learns the base images of the block units, using the still images of the learning brightness images of the block units and a cost function including a term showing the spatial correspondence between the base image coefficients. The learning unit 12 supplies the learned base images of the block units to the storage unit 13.

The storage unit 13 stores the base images of the block units that are supplied from the learning unit 12.

### Example of Blocks

FIG. 3 is a diagram illustrating a first example of blocks divided by the dividing unit 11 of FIG. 2.

In the example of FIG. 3, the dividing unit 11 divides a still image 30 of a learning brightness image into blocks having predetermined sizes. Therefore, a block 31 and a block 32 that are adjacent to each other in a horizontal direction and the block 31 and a block 33 that are adjacent to each other in a vertical direction do not overlap each other.

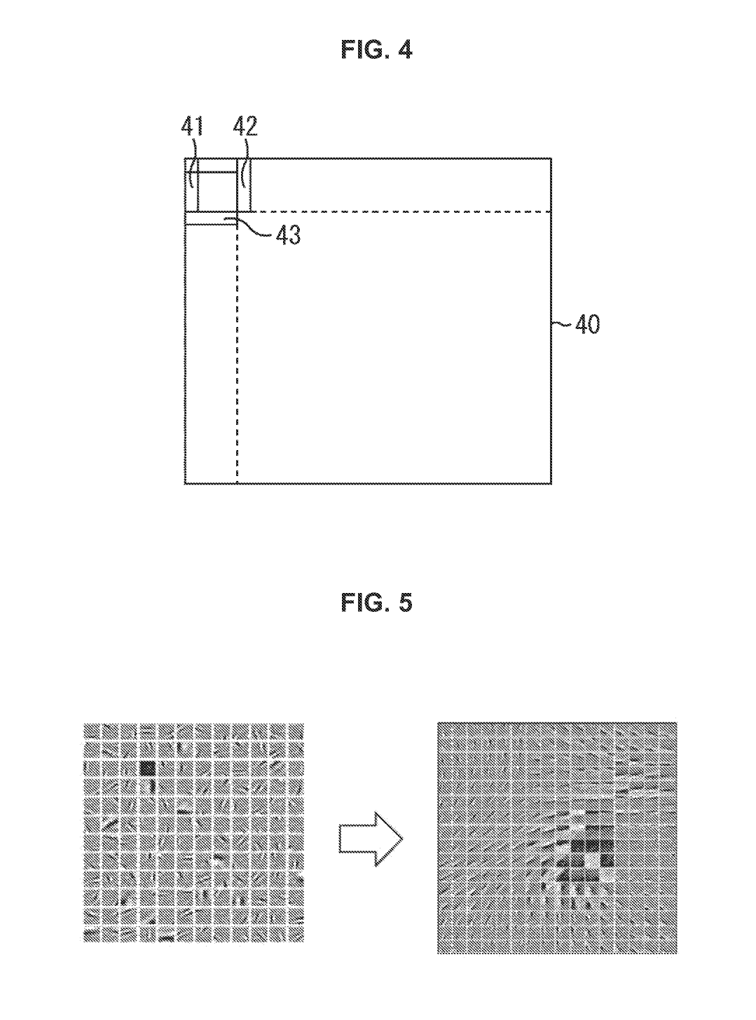

FIG. 4 is a diagram illustrating a second example of blocks divided by the dividing unit 11 of FIG. 2.

In the example of FIG. 4, the dividing unit 11 divides a still image 40 of a learning brightness image into blocks having predetermined sizes (block sizes) that are adjacent to each other in a horizontal direction and a vertical direction at intervals (in the example of FIG. 4, ¼ of the block sizes) smaller than the block sizes. Therefore, a block 41 and a block 42 that are adjacent to each other in the horizontal direction and the block 41 and a block 43 that are adjacent to each other in the vertical direction overlap each other.

As illustrated in FIG. 4, in the case in which the blocks are divided to overlap each other, a learning processing amount increases, but learning precision is improved, as compared with the case of FIG. 3. A shape of the blocks is not limited to a square.

### [Explanation of Learning]

FIG. 5 is a diagram illustrating a background of learning in the learning unit 12 of FIG. 2.

In FIG. 5, individual squares show the base images of the block units and the base images of the block units are arranged in the horizontal direction and the vertical direction.

Recently, it has been known that ignition of a neuron is not generated randomly and has a correlation with ignition of surrounding neurons (topographic structure), from the latest study on the human visual system.

However, in the learning according to the related art based on the cost function defined by any one of the expressions 2 to 4 described above, it is assumed that there is no correspondence between the base image coefficients. As illustrated at the left side of FIG. 5, there is no spatial correspondence between the learned base images.

Therefore, the learning unit 12 learns the base images, under the restriction condition in which there is the spatial correspondence between the base image coefficients, so that the learning unit 12 learns the base images using a model optimized for the human visual system. As a result, there is the spatial correspondence between the learned base images, as illustrated at the right side of FIG. 5.

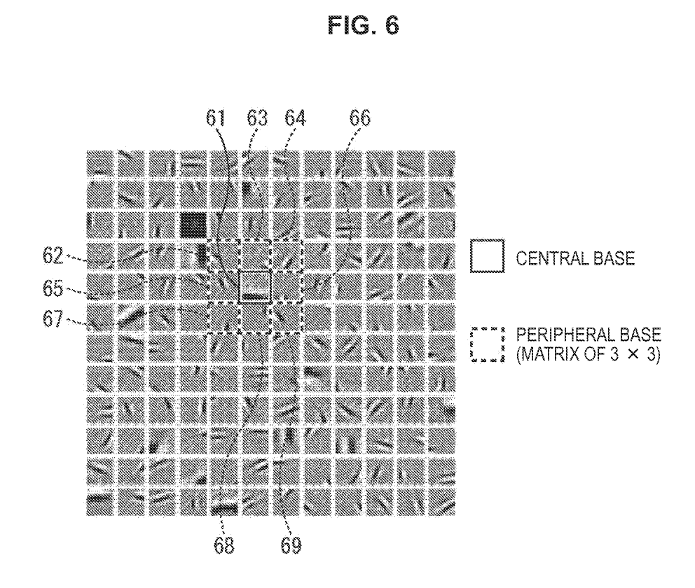

FIG. 6 is a diagram illustrating a restriction condition when learning is performed by the learning unit 12 of FIG. 2.

The learning unit 12 learns the base images in which there is the spatial correspondence between the base image coefficients. For this reason, as illustrated in FIG. 6, the learning unit 12 applies a restriction condition in which a base image coefficient of a base image 61 of the block unit has the same sparse representation (zero or non-zero) as base image coefficients of 3×3 base images 61 to 69 of the block units based on the base image 61, when the cost function is operated.

Specifically, the learning unit 12 defines the cost function by the following expression 5.

L=argmin{∥Dα−Y∥²+μΣᵢF(Σⱼh(i,j)αⱼ²)}

F(y)=a\sqrt{y}+b (5)

In the expression 5, D denotes a base image matrix (hereinafter, referred to as a block unit base image matrix) of the block unit and α denotes a base image coefficient vector (hereinafter, referred to as a block unit base image coefficient vector) of the block unit. In addition, Y denotes a vector (hereinafter, referred to as a learning brightness image vector) in which pixel values of individual pixels of still images of learning brightness images of the block units are arranged in a column direction and μ denotes a previously set parameter.

In addition, h(i, j) denotes a coefficient (hereinafter, referred to as a correspondence coefficient) that shows a correspondence relation of a base image coefficient of an i-th (i=1, . . . , and n (base image number)) base image of the block unit and a base image coefficient of a j-th (j=1, . . . , and 9) base image of the block unit among 3×3 base images of the block units based on the i-th base image of the block unit. In addition, αⱼ denotes a base image coefficient of the j-th (j=1, . . . , and 9) base image of the block unit. Therefore, a second term in armin ( ) of the right side of the expression 5 is a term that shows a spatial correspondence between the base image coefficients.

The learning unit 12 learns the base images by a steepest descent method, using the cost function defined as described above. Specifically, the learning unit 12 executes the following processing with respect to all blocks of the still images of all the learning brightness images.

First, as represented by the following expression 6, the learning unit 12 partially differentiates the cost function defined by the expression 5 with respect to the block unit base image coefficient vector, sets a value of the block unit base image matrix to an initial value, and calculates Δα. As the initial value of the block unit base image matrix, a random value or a predetermined value is used.

$$Δα = \frac{\partial L}{\partial α} = 2 {D}^{T} ( D α - Y ) + {μΣ}_{i} F ( {α}^{T} {H}_{i} α ) {H}_{i} α \\ {α}^{T} {H}_{i} α = {Σ}_{j} h ( i , j ) {α}_{j}^{2} \qquad ( 6 )$$

In the expression 6, D denotes a block unit base image matrix, α denotes a block unit base image coefficient vector, Y denotes a learning brightness image vector, and μ denotes a previously set parameter. In addition, h(i, j) denotes a correspondence coefficient and αⱼ denotes a base image coefficient of the j-th (j=1, . . . , and 9) base image of the block unit.

Next, the learning unit 12 updates the block unit base image coefficient vector using Δα, as represented by the following expression 7.

α=α+η₁Δα (7)

In the expression 7, α denotes a block unit base image coefficient vector and η₁ denotes a parameter of the steepest descent method.

In addition, as represented by the following expression 8, the learning unit 12 partially differentiates the cost function defined by the expression 5 with respect to the block unit base image matrix and calculates ΔD using the updated block unit base image coefficient vector.

$$Δ D = \frac{\partial L}{\partial D} = - ( Y - D α ) {α}^{T} \qquad ( 8 )$$

In the expression 8, Y denotes a learning brightness image vector, D denotes a block unit base image matrix, and α denotes a block unit base image coefficient vector.

Next, the learning unit 12 updates the block unit base image matrix using ΔD, as represented by the following expression 9.

D=D+η₂ΔD (9)

In the expression 9, D denotes a block unit base image matrix and η₂ denotes a parameter of the steepest descent method.

The learning unit 12 operates the cost function defined by the expression 5 with respect to all blocks of the still images of all the learning brightness images, using the updated block unit base image matrix and block unit base image coefficient vector. When a sum of the cost functions is not a predetermined value or less, the learning unit 12 repeats updating of the block unit base image matrix and the block unit base image coefficient vector, until the sum of the cost functions becomes the predetermined value or smaller. When the sum of the cost functions is the predetermined value or smaller, the learning unit 12 uses the base images of the block units constituting the updated block unit base image matrix as a learning result.

In the present disclosure, j is 9. However, j may be any value that is equal to or greater than 2.

### [Explanation of Processing of Learning Apparatus]

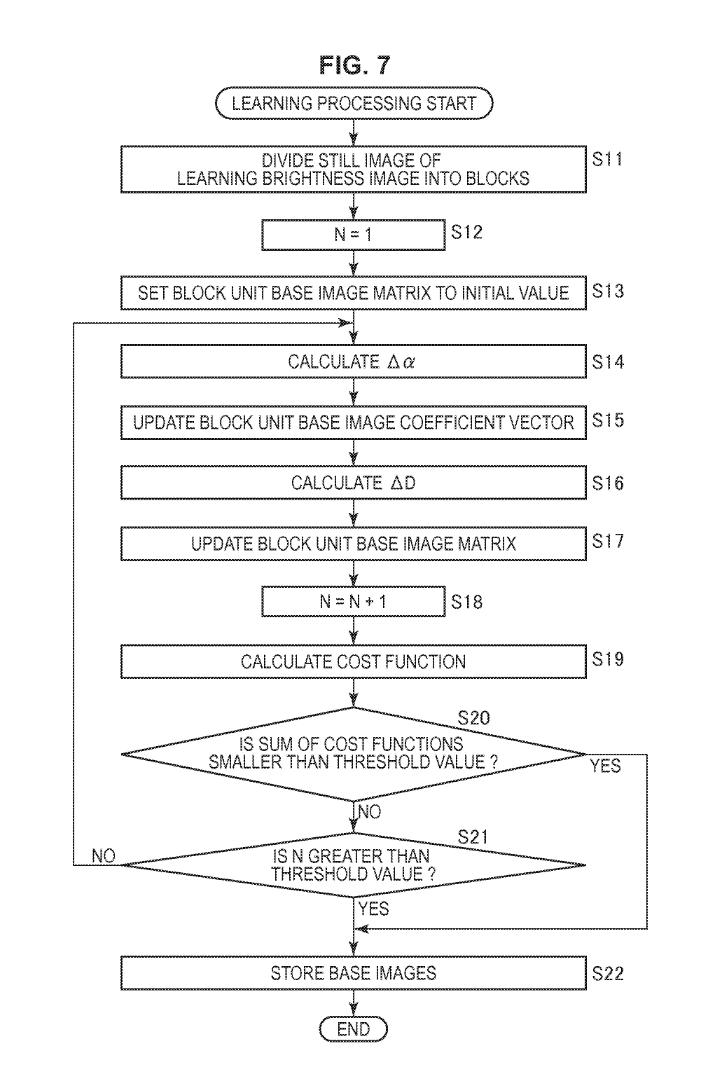

FIG. 7 is a flowchart illustrating learning processing of the learning apparatus 10 of FIG. 2. The learning processing is performed off-line when the still images of all the learning brightness images are from the outside to the learning apparatus 10.

In step S11 of FIG. 7, the dividing unit 11 divides the still image of the learning brightness image input from the outside into the blocks having the predetermined sizes and supplies the blocks to the learning unit 12. In step S12, the learning unit 12 sets the number of times N of repeating the learning to 1. Processing of following steps S13 to S17 and S19 is executed for every block, with respect to all blocks of the still images of all the learning brightness images.

In step S13, the learning unit 12 sets the value of the block unit base image matrix to the initial value. In step S14, the learning unit 12 calculates Δα by the expression 6, using the set block unit base image matrix and the blocks supplied from the dividing unit 11.

In step S15, the learning unit 12 updates the block unit base image coefficient vector by the expression 7, using Δα calculated by step S14. In step S16, the learning unit 12 calculates ΔD by the expression 8, using the block unit base image coefficient vector updated by step S15 and the blocks.

In step S17, the learning unit 12 updates the block unit base image matrix by the expression 9, using ΔD calculated by step S16. In step S18, the learning unit 12 increments the number of times N of repeating the learning by 1.

In step S19, the learning unit 12 calculates the cost function by the expression 5, using the block unit base image coefficient vector updated by step S15, the block unit base image matrix updated by step S17, and the blocks.

In step S20, the learning unit 12 determines whether the sum of the cost functions of all the blocks of the still images of all the learning brightness images is smaller than the predetermined threshold value. When it is determined in step S20 that the sum of the cost functions is equal to or greater than the predetermined threshold value, the processing proceeds to step S21.

In step S21, the learning unit 12 determines whether the number of times N of repeating the learning is greater than the predetermined threshold value. When it is determined in step S21 that the number of times N of repeating the learning is the predetermined threshold value or less, the processing returns to step S14. The processing of steps S14 to S21 is repeated until the sum of the cost functions becomes smaller than the predetermined threshold value or the number of times N of repeating the learning becomes greater than the predetermined threshold value.

Meanwhile, when it is determined in step S20 that the sum of the cost functions is smaller than the predetermined threshold value or when it is determined in step S21 that the number of times N of repeating the learning is greater than the predetermined threshold value, the processing proceeds to step S22.

In step S22, the learning unit 12 supplies the base images of the block units constituting the block unit base image matrix updated by immediately previous step S17 to the storage unit 13 and causes the storage unit 13 to store the base images.

In this case, the block unit base image matrix is repetitively learned using all the blocks of the still images of all the learning brightness images. However, repetition learning using each block may be sequentially performed.

As described above, the learning apparatus 10 learns the base images using the cost function including the term showing the spatial correspondence between the base image coefficients, such that the still image of the learning brightness image is represented by a linear operation of the base images in which the base image coefficients become sparse. Therefore, the base images can be learned using the model optimized for the human visual system. As a result, accurate base images can be learned.

### First Configuration Example of Image Generating Apparatus

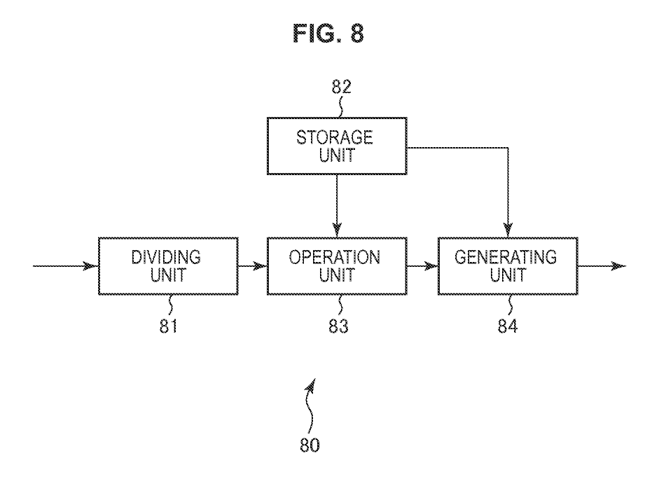

FIG. 8 is a block diagram illustrating a first configuration example of an image generating apparatus that generates an image using the base images learned by the learning apparatus 10 of FIG. 2 and corresponds to a first embodiment of an output apparatus to which the present disclosure is applied.

As illustrated in FIG. 8, an image generating apparatus 80 includes a dividing unit 81, a storage unit 82, an operation unit 83, and a generating unit 84. The image generating apparatus 80 performs the sparse coding with respect to a still image of a brightness image input as a deteriorated image from the outside and generates a restored image.

Specifically, the still image of the brightness image is input as the deteriorated image from the outside to the dividing unit 81 of the image generating apparatus 80. The dividing unit 81 divides the deteriorated image input from the outside into blocks having predetermined sizes and supplies the blocks to the operation unit 83, similar to the dividing unit 11 of FIG. 2.

The storage unit 82 stores the base images of the block units that are learned by the learning apparatus 10 of FIG. 2 and are stored in the storage unit 13.

The operation unit 83 reads the base image of the block unit from the storage unit 82. The operation unit 83 operates the block unit base image coefficient vector, for each block of the deteriorated image supplied from the dividing unit 81, such that the cost function becomes smaller than the predetermined threshold value. The cost function is defined by an expression obtained by setting Y of the expression 5 to a vector (hereinafter, referred to as a deteriorated image vector) where pixel values of individual pixels of blocks of the deteriorated image are arranged in the column direction, using the block unit base image matrix including the read base image of the block unit. The operation unit 83 supplies the block unit base image coefficient vector to the generating unit 84.

The generating unit 84 reads the base image of the block unit from the storage unit 82. The generating unit 84 generates the still image of the brightness image of the block unit by the following expression 10, for each block, using the block unit base image coefficient vector supplied from the operation unit 83 and the block unit base image matrix including the read base image of the block unit.

X=D×α (10)

In the expression 10, X denotes a vector (hereinafter, referred to as a block unit generation image vector) in which pixel values of individual pixels of the generated still image of the brightness image of the block unit are arranged in the column direction, D denotes a block unit base mage matrix, and α denotes a block unit base image coefficient vector.

The generating unit 84 generates a still image of one brightness image from the still image of the brightness image of the block unit of each block and outputs the still image as a restored image.

### [Explanation of Processing of Generating Unit]

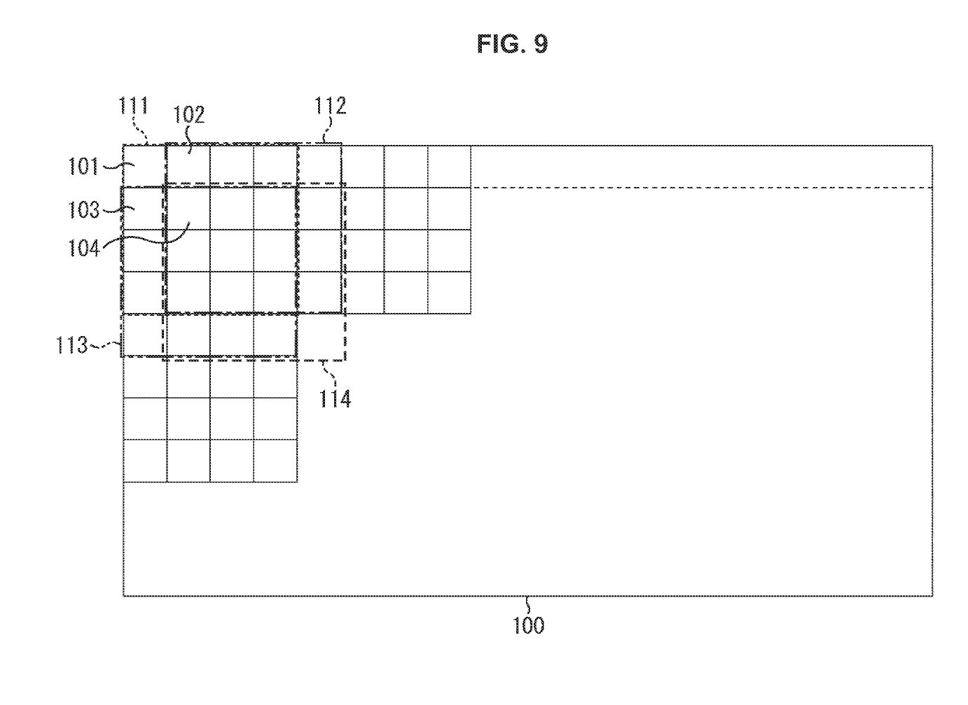

FIG. 9 is a diagram illustrating processing of the generating unit 84 of FIG. 8 when the dividing unit 81 divides the deteriorated image into the blocks illustrated in FIG. 4.

In FIG. 9, a square of a solid line shows a pixel and a square of a dotted line shows a block. In an example of FIG. 9, a size of the block is 4×4 pixels.

As illustrated in FIG. 9, when the dividing unit 81 divides a deteriorated image 100 into the blocks illustrated in FIG. 4, the generating unit 84 generates an average value of components of a block unit generation image vector of a block corresponding to each pixel, as a pixel value of each pixel of the restored image.

Specifically, an upper left pixel 101 is included in only a block 111. Therefore, the generating unit 84 sets a pixel value of the pixel 101 as a component of a block unit generation image vector of the block 111 corresponding to the pixel 101.

Meanwhile, a pixel 102 that is adjacent to the right side of the pixel 101 is included in the block 111 and a block 112. Therefore, the generating unit 84 sets a pixel value of the pixel 102 as an average value of components of block unit generation image vectors of the block 111 and the block 112 corresponding to the pixel 102.

A pixel 103 that is arranged below the pixel 101 is included in the block 111 and a block 113. Therefore, the generating unit 84 sets a pixel value of the pixel 103 as an average value of components of block unit generation image vectors of the block 111 and the block 113 corresponding to the pixel 103.

A pixel 104 that is adjacent to the right side of the pixel 103 is included in the block 111 to a block 114. Therefore, the generating unit 84 sets a pixel value of the pixel 104 as an average value of components of block unit generation image vectors of the block 111 to the block 114 corresponding to the pixel 104.

Meanwhile, although not illustrated in the drawings, when the dividing unit 81 divides the deteriorated image into the blocks illustrated in FIG. 3, the generating unit 84 synthesizes each component of a block unit generation image vector of each block as a pixel value of a pixel corresponding to each component and generates a restored image.

### [Explanation of Processing of Image Generating Apparatus 80]

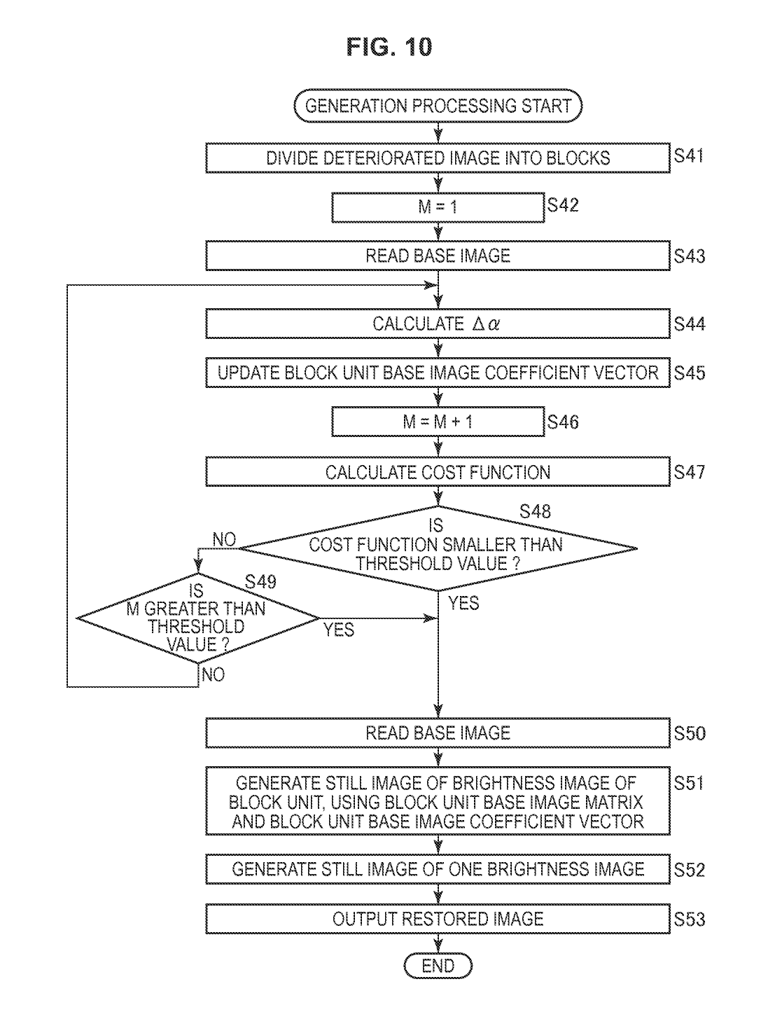

FIG. 10 is a flowchart illustrating generation processing of the image generating apparatus 80 of FIG. 8. The generation processing starts when a still image of a brightness image is input as a deteriorated image from the outside.

In step S41 of FIG. 10, the dividing unit 81 of the image generating apparatus 80 divides the still image of the brightness image input as the deteriorated image from the outside into blocks having predetermined sizes and supplies the blocks to the operation unit 83, similar to the dividing unit 11 of FIG. 2. Processing of following steps S42 to S51 is executed in the block unit.

In step S42, the operation unit 83 sets the number of times M of repeating the operation of the block unit base image coefficient vector to 1.

In step S43, the operation unit 83 reads the base image of the block unit from the storage unit 82. In step S44, the operation unit 83 calculates Δα by an expression obtained by setting Y of the expression 6 to the deteriorated image vector, using the block unit base image matrix including the read base image of the block unit and the blocks supplied from the dividing unit 81.

In step S45, the operation unit 83 updates the block unit base image coefficient vector by the expression 7, using Δα calculated by step S44. In step S46, the operation unit 83 increments the number of times M of repeating the operation by 1.

In step S47, the operation unit 83 calculates the cost function by an expression obtained by setting Y of the expression 5 to the deteriorated image vector, using the block unit base image coefficient vector updated by step S45, the block unit base image matrix, and the blocks of the deteriorated image.

In step S48, the operation unit 83 determines whether the cost function is smaller than the predetermined threshold value. When it is determined in step S48 that the cost function is the predetermined threshold value or greater, in step S49, the operation unit 83 determines whether the number of times M of repeating the operation is greater than the predetermined threshold value.

When it is determined in step S49 that the number of times M of repeating the operation is the predetermined threshold value or less, the operation unit 83 returns the processing to step S44. The processing of steps S44 to S49 is repeated until the cost function becomes smaller than the predetermined threshold value or the number of times M of repeating the operation becomes greater than the predetermined threshold value.

Meanwhile, when it is determined in step S48 that the cost function is smaller than the predetermined threshold value or when it is determined in step S49 that the number of times M of repeating the operation is greater than the predetermined threshold value, the operation unit 83 supplies the block unit base image coefficient vector updated by immediately previous step S45 to the generating unit 84.

In step S50, the generating unit 84 reads the base image of the block unit from the storage unit 82. In step S51, the generating unit 84 generates the still image of the brightness image of the block unit by the expression 10, using the block unit base image matrix including the read base image of the block unit and the block unit base image coefficient vector supplied from the operation unit 83.

In step S52, the generating unit 84 generates a still image of one brightness image from the still image of the brightness image of the block unit, according to a block division method. In step S53, the generating unit 84 outputs the generated still image of one brightness image as a restored image, and the processing ends.

As described above, the image generating apparatus 80 obtains the base images learned by the learning apparatus 10 and operates the base image coefficients on the basis of the base images, the deteriorated image, and the cost function including the term showing the spatial correspondence between the base image coefficients. Therefore, the image generating apparatus 80 can obtain the base images and the base image coefficients according to the model optimized for the human visual system. As a result, the image generating apparatus 80 can generate a high-definition restored image, using the obtained base images and base image coefficients.

### Second Configuration Example of Image Generating Apparatus

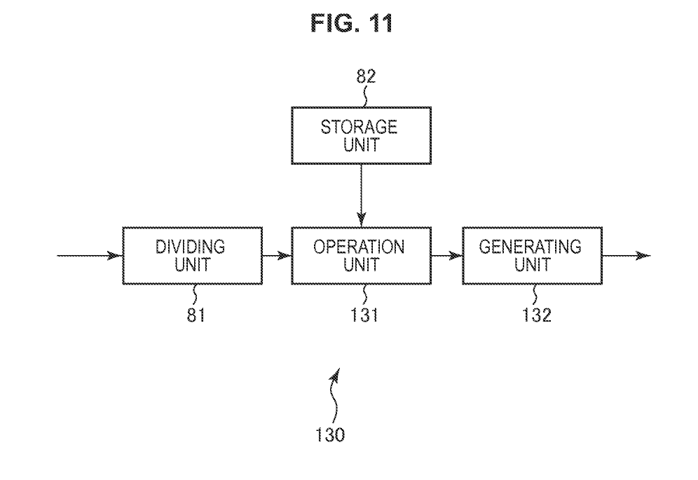

FIG. 11 is a block diagram illustrating a second configuration example of an image generating apparatus that generates an image using the base images learned by the learning apparatus 10 of FIG. 2 and corresponds to the first embodiment of the output apparatus to which the present disclosure is applied.

Among structural elements illustrated in FIG. 11, the structural elements that are the same as the structural elements of FIG. 8 are denoted with the same reference numerals. Repeated explanation of these structural elements is omitted.

A configuration of an image generating apparatus 130 of FIG. 11 is different from the configuration of FIG. 8 in that an operation unit 131 is provided, instead of the operation unit 83, and a generating unit 132 is provided, instead of the generating unit 84. The image generating apparatus 130 generates a restored image and learns base images.

Specifically, the operation unit 131 of the image generating apparatus 130 reads the base image of the block unit from the storage unit 82, similar to the operation unit 83 of FIG. 8. The operation unit 131 operates the block unit base image coefficient vector while learning the block unit base image matrix, for each block of the deteriorated image supplied from the dividing unit 81, such that the cost function becomes smaller than the predetermined threshold value.

The cost function is defined by an expression obtained by setting Y of the expression 5 to a deteriorated image vector, using the block unit base image matrix including the read base image of the block unit. The operation unit 131 supplies the learned block unit base image matrix and the block unit base image coefficient vector to the generating unit 132.

The generating unit 132 generates the still image of the brightness image of the block unit by the expression 10, for each block, using the block unit base image coefficient vector and the block unit base image matrix supplied from the operation unit 131. The generating unit 132 generates a still image of one brightness image from the still image of the brightness image of the block unit of each block and outputs the still image as a restored image, similar to the generating unit 84 of FIG. 8.

### [Explanation of Processing of Image Generating Apparatus 130]

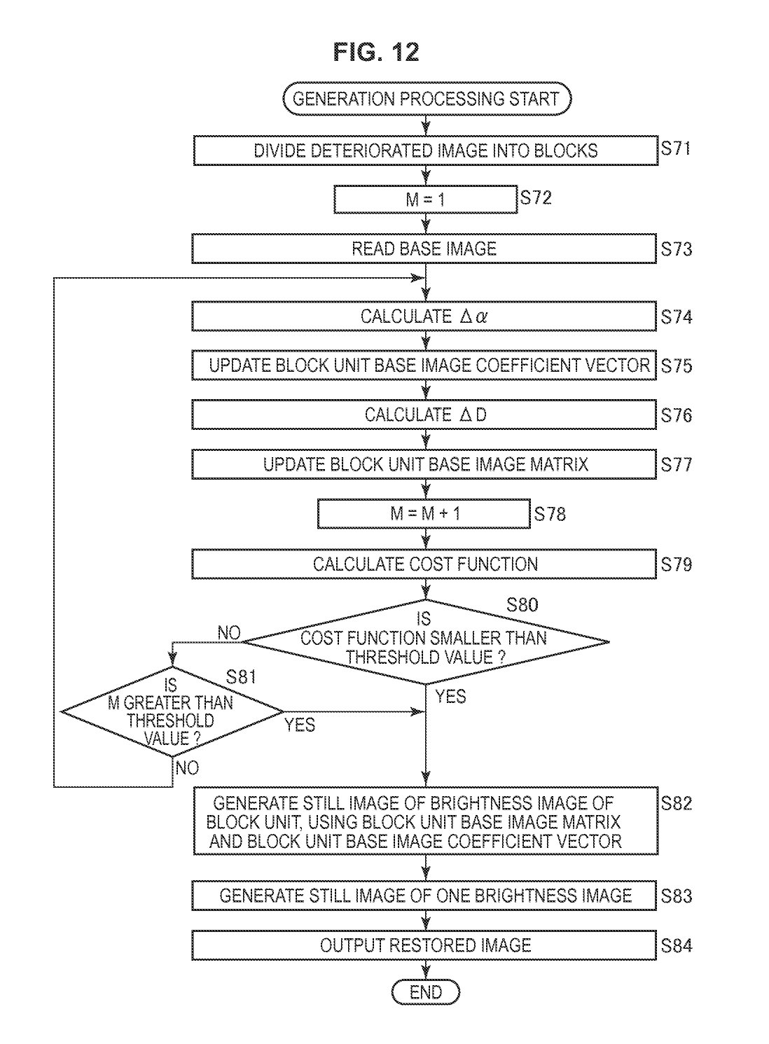

FIG. 12 is a flowchart illustrating generation processing of the image generating apparatus 130 of FIG. 11. The generation processing starts when a still image of a brightness image is input as a deteriorated image from the outside.

Because processing of steps S71 to S75 of FIG. 12 is the same as the processing of steps S41 to S45 of FIG. 10, repeated explanation thereof is omitted. Processing of following steps S76 to S82 is executed in the block unit.

In step S76, the operation unit 131 calculates ΔD by an expression obtained by setting Y of the expression 8 to the deteriorated image vector, using the block unit base image coefficient vector updated by step S75 and the blocks of the deteriorated image.

In step S77, the operation unit 131 updates the block unit base image matrix by the expression 9, using ΔD calculated by step S77. In step S78, the operation unit 131 increments the number of times M of repeating the operation by 1.

In step S79, the operation unit 131 calculates the cost function by an expression obtained by setting Y of the expression 5 to the deteriorated image vector, using the block unit base image coefficient vector updated by step S75, the block unit base image matrix updated by step S77, and the blocks of the deteriorated image.

In step S80, the operation unit 131 determines whether the cost function is smaller than the predetermined threshold value. When it is determined in step S80 that the cost function is the predetermined threshold value or greater, the processing proceeds to step S81.

In step S81, the operation unit 131 determines whether the number of times M of repeating the operation is greater than the predetermined threshold value. When it is determined in step S81 that the number of times M of repeating the operation is the predetermined threshold value or less, the processing returns to step S74. The processing of steps S74 to S81 is repeated until the cost function becomes smaller than the predetermined threshold value or the number of times M of repeating the operation becomes greater than the predetermined threshold value.

Meanwhile, when it is determined in step S80 that the cost function is smaller than the predetermined threshold value or when it is determined in step S81 that the number of times M of repeating the operation is greater than the predetermined threshold value, the operation unit 131 supplies the block unit base image coefficient vector updated by immediately previous step S75 and the block unit base image matrix updated by step S77 to the generating unit 132.

In step S82, the generating unit 132 generates the still image of the brightness image of the block unit by the expression 10, using the block unit base image coefficient vector and the block unit base image matrix supplied from the operation unit 131.

Because processing of steps S83 and S84 is the same as the processing of steps S52 and S53 of FIG. 10, explanation thereof is omitted.

In the generation processing of FIG. 12, the block unit base image matrix is updated for each block. However, the block unit base image matrix may be updated in a deteriorated image unit. In this case, the cost functions are calculated with respect to all the blocks of the deteriorated image and a repetition operation is performed on the basis of a sum of the cost functions.

As described above, because the image generating apparatus 130 generates a restored image and learns the base image of the block unit, precision of the base image of the block unit can be improved and a high-definition restored image can be generated.

However, in the image generating apparatus 130, because it is necessary to perform learning whenever a deteriorated image is input, that is, perform on-line learning, a high processing ability is requested. Therefore, it is preferable to apply the image generating apparatus 130 to a personal computer having a relatively high processing ability and apply the image generating apparatus 80 to a digital camera or a portable terminal having a relatively low processing ability.

In the first embodiment, the learning image and the deteriorated image are the still images of the brightness images. However, the learning image and the deteriorated image may be still images of color images.

When the learning image and the deteriorated image are the still images of the color images, the still images of the color images are divided into blocks having predetermined sizes, for each color channel (for example, R (Red), G (Green), and B (Blue). As represented by the following expression 11, a cost function is defined for each color channel. As a result, the learning apparatus 10 learns the base image of the block unit for each color channel and the image generating apparatus 80 (130) generates the still image of the color image for each color channel.

L^{R}=argmin{∥D^{R}α^{R}−R∥²+μΣᵢF(Σⱼh(i,j)α^{R}ⱼ²)}

L^{G}=argmin{∥D^{G}α^{G}−G∥²+μΣᵢF(Σⱼh(i,j)α^{G}ⱼ²)}

L^{B}=argmin{∥D^{B}α^{B}−B∥²+μΣᵢF(Σⱼh(i,j)α^{B}ⱼ²)}

F(y)=a\sqrt{y}+b (11)

In the expression 11, L^{R}, L^{G}, and L^{B} denote cost functions of the color channels of R, G, and B, respectively, and D^{R}, D^{G}, and D^{B} denote block unit base image matrixes of the color channels of R, G, and B, respectively. In addition, α^{R}, α^{G}, and α^{B} denote block unit base image coefficient vectors of the color channels of R, G, and B, respectively, and R, G, and B denote vectors (hereinafter, referred to as learning color image vectors) in which pixel values of individual pixels of still images of learning color images of block units of the color channels of R, G, and B are arranged in a column direction, respectively. In addition, μ denotes a previously set parameter.

In addition, h(i, j) denotes a correspondence coefficient. In addition, α^{R}ⱼ, α^{G}ⱼ, and α^{B}ⱼ denote base image coefficients of j-th (j=1, . . . , and 9) base images of the block units among 3×3 base images of the block units based on i-th (i=1, . . . , and n (base image number)) base images of the block units of the color channels of R, G, and B, respectively. In addition, a, y, and b denote previously set parameters.

The learning image and the deteriorated image may be moving images. In this case, the moving images are divided into blocks having predetermined sizes, for each frame.

### Second Embodiment

### Configuration Example of Learning Apparatus

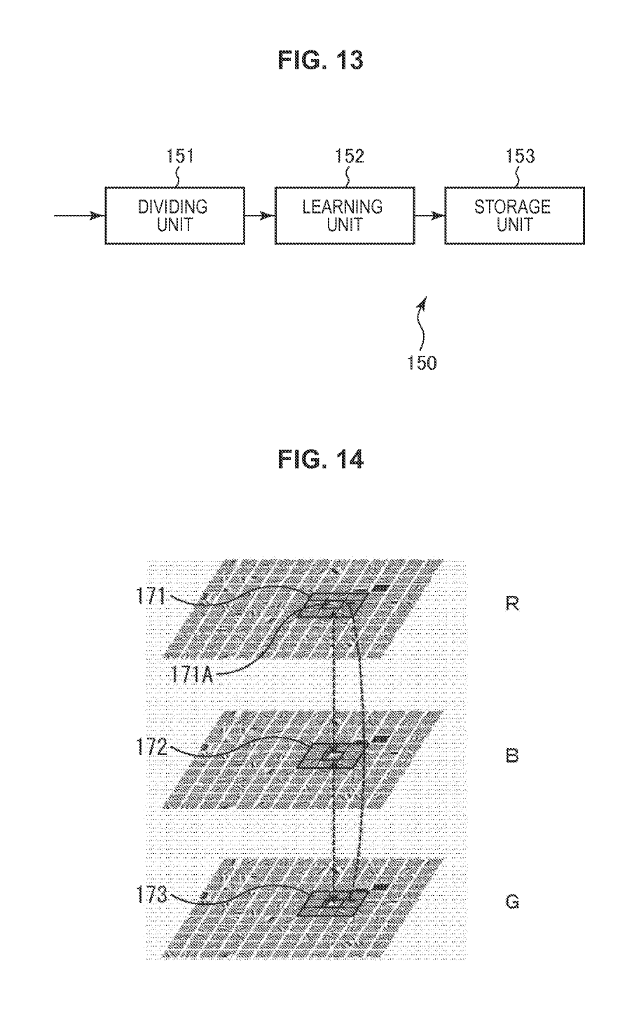

FIG. 13 is a block diagram illustrating a configuration example of a learning apparatus that corresponds to a second embodiment of the signal processing apparatus to which the present disclosure is applied.

A learning apparatus 150 of FIG. 13 includes a dividing unit 151, a learning unit 152, and a storage unit 153. The learning apparatus 150 learns base images using still images of learning color images of individual color channels, such that there is a correspondence between base image coefficients of the individual color channels and there is a spatial correspondence between the base image coefficients of all the color channels.

Specifically, still images of a large amount of learning color images of the individual color channels that do not have image quality deterioration are input from the outside to the dividing unit 151. The dividing unit 151 divides the still image of the learning color image into blocks having predetermined sizes, for each color channel, and supplies the blocks to the learning unit 152.

The learning unit 152 models the blocks of the individual color channels supplied from the dividing unit 151 using the expression 1 described above and learns base images of block units of the individual color channels, under a restriction condition in which there is the correspondence between the base image coefficients of the individual color channels and there is the spatial correspondence between the base image coefficients of all the color channels.

Specifically, the learning unit 152 learns the base images of the block units of the individual color channels, using the blocks of the individual color channels and a cost function including a term showing the correspondence between the base image coefficients of the individual color channels and the spatial correspondence between the base image coefficients of all the color channels. The learning unit 152 supplies the learned base images of the block units of the individual color channels to the storage unit 153 and causes the storage unit 153 to store the base images.

### [Explanation of Restriction Condition]

FIG. 14 is a diagram illustrating a restriction condition when learning is performed by the learning unit 152 of FIG. 13.

The learning unit 152 learns the base images in which there is the correspondence between the base image coefficients of the individual color channels and there is the spatial correspondence between the base image coefficients of all the color channels. For this reason, as illustrated in FIG. 14, the learning unit 152 applies a restriction condition in which base image coefficients of a base image 171A of the block unit of the color channel of R, a base image group 171 including 3×3 base images of the block units based on the base image 171A, a base image group 172 of the color channel of B at the same position as the base image group 171, and a base image group 173 of the color channel of G at the same position as the base image group 171 have the same sparse representation, when a cost function is operated.

Specifically, the learning unit 152 defines the cost function by the following expression 12.

L=argmin{∥D^{R}α^{R}−R∥²+∥D^{G}α^{G}−G∥²+∥D^{B}α^{B}−B∥²

+μΣᵢF(Σⱼh(i,j)(α^{R}ⱼ²+α^{G}ⱼ²+α^{B}ⱼ²))}

F(y)=a\sqrt{y}+b (12)

In the expression 12, D^{R}, D^{G}, and D^{B} denote block unit base image matrixes of the color channels of R, G, and B, respectively, and α^{R}, α^{G}, and α^{B} denote block unit base image coefficient vectors of the color channels of R, G, and B, respectively. In addition, R, G, and B denote learning color image vectors of the color channels of R, G, and B and μ denotes a previously set parameter.

In addition, h(i, j) denotes a correspondence coefficient. In addition, α^{R}ⱼ, α^{G}ⱼ, and α^{B}ⱼ denote base image coefficients of the j-th (j=1, . . . , and 9) base images of block units among 3×3 base images of the block units based on the i-th (i=1, . . . , and n (base image number)) base images of the block units of the color channels of R, G, and B, respectively. In addition, a, y, and b denote previously set parameters.

Therefore, a fourth term in argmin ( ) of the right side of the expression 12 is a term that shows the correspondence between the base image coefficients of the individual color channels and the spatial correspondence between the base image coefficients of all the color channels.

### [Explanation of Processing of Learning Apparatus]

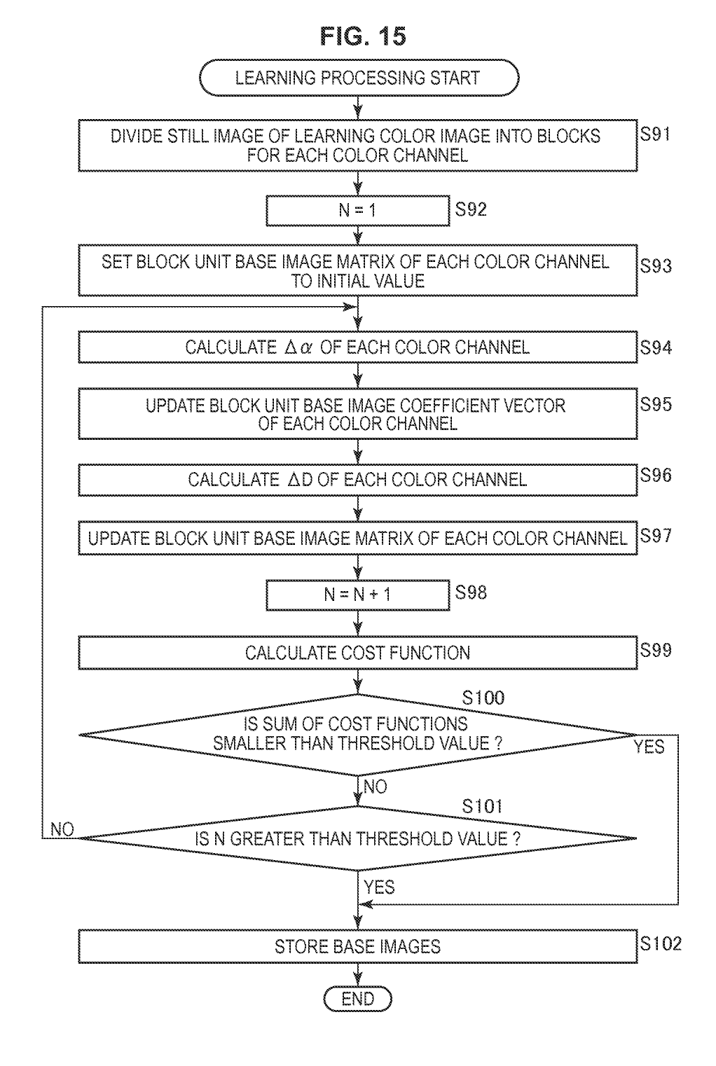

FIG. 15 is a flowchart illustrating learning processing of the learning apparatus 150 of FIG. 13. The learning processing is performed off-line when the still images of all the learning brightness images are from the outside to the learning apparatus 10.

In step S91 of FIG. 15, the dividing unit 151 divides the still image of the learning color image input from the outside into the blocks having the predetermined sizes, for each color channel, and supplies the blocks to the learning unit 152. In step S92, the learning unit 12 sets the number of times N of repeating the learning to 1. Processing of following steps S93 to S97 and S99 is executed for every block, with respect to all the blocks of the still images of all the learning brightness images.

In step S93, the learning unit 152 sets a value of the block unit base image matrix of each color channel to an initial value.

In step S94, the learning unit 152 calculates Δα of each color channel, using the set block unit base image matrix of each color channel and the blocks of each color channel supplied from the dividing unit 151. Specifically, the learning unit 152 calculates Δα of each color channel by an expression obtained by partially differentiating the cost function defined by the expression 12 with respect to the block unit base image coefficient vector of each color channel, using the block unit base image matrix of each color channel and the blocks of each color channel.

In step S95, the learning unit 152 updates the block unit base image coefficient vector of each color channel by the expression 7, for each color channel, using Δα of each color channel calculated by step S94.

In step S96, the learning unit 152 calculates ΔD of each color channel, using the block unit base image coefficient vector of each color channel updated by step S95 and the blocks of each color channel. Specifically, the learning unit 152 calculates ΔD of each color channel by an expression obtained by partially differentiating the cost function defined by the expression 12 with respect to the block unit base image matrix of each color channel, using the block unit base image coefficient vector of each color channel and the blocks of each color channel.

In step S97, the learning unit 152 updates the block unit base image matrix of each color channel by the expression 9, for each color channel, using ΔD of each color channel calculated by step S96. In step S98, the learning unit 152 increments the number of times N of repeating the learning by 1.

In step S99, the learning unit 152 calculates the cost function by the expression 12, using the block unit base image coefficient vector of each color channel updated by step S95, the block unit base image matrix of each color channel updated by step S97, and the blocks of each color channel.

Because processing of steps S100 and S101 is the same as the processing of steps S20 and S21 of FIG. 7, explanation thereof is omitted.

In step S102, the learning unit 152 supplies the base images of the block units constituting the block unit base image matrix of each color channel updated by immediately previous step S97 to the storage unit 153 and causes the storage unit 153 to store the base images.

As described above, the cost function in the learning apparatus 150 includes the term showing the correspondence between the base image coefficients of the individual color channels as well as the spatial correspondence between the base image coefficients of all the color channels, similar to the case of the learning apparatus 10. Therefore, base images can be learned using a model that is optimized for the human visual system and suppresses false colors from being generated. As a result, accurate base images can be learned.

### Configuration Example of Image Generating Apparatus

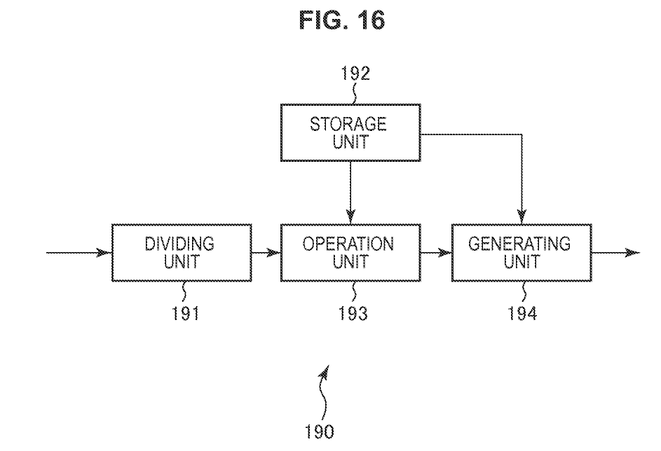

FIG. 16 is a block diagram illustrating a configuration example of an image generating apparatus that generates an image using the base images of the individual color channels learned by the learning apparatus 150 of FIG. 13 and corresponds to a second embodiment of the output apparatus to which the present disclosure is applied.

An image generating apparatus 190 of FIG. 16 includes a dividing unit 191, a storage unit 192, an operation unit 193, and a generating unit 194. The image generating apparatus 190 performs the sparse coding with respect to a still image of a color image input as a deteriorated image from the outside and generates a restored image.

Specifically, the still image of the color image is input as the deteriorated image from the outside to the dividing unit 191 of the image generating apparatus 190. The dividing unit 191 divides the deteriorated image input from the outside into blocks having predetermined sizes, for each color channel, and supplies the blocks to the operation unit 193, similar to the dividing unit 151 of FIG. 13.

The storage unit 192 stores the base image of the block unit of each color channel that is learned by the learning apparatus 150 of FIG. 13 and is stored in the storage unit 153.

The operation unit 193 reads the base image of the block unit of each color channel from the storage unit 192. The operation unit 193 operates the block unit base image coefficient vector of each color channel, for each block of the deteriorated image supplied from the dividing unit 191, such that the cost function becomes smaller than the predetermined threshold value. The cost function is defined by an expression obtained by setting R, G, and B of the expression 12 to deteriorated image vectors of the color channels of R, G, and B, using the block unit base image matrix including the read base image of the block unit of each color channel. The operation unit 193 supplies the block unit base image coefficient vector of each color channel to the generating unit 194.

The generating unit 194 reads the base image of the block unit of each color channel from the storage unit 192. The generating unit 194 generates the still image of the color image by an expression obtained by setting the brightness image of the expression 10 to the color image of each color channel, for each block of each color channel, using the block unit base image coefficient vector of each color channel supplied from the operation unit 193 and the block unit base image matrix including the read base image of the block unit of each color channel.

The generating unit 194 generates a still image of one color image of each color channel from the still image of the color image of the block of each color channel and outputs the still image as a restored image.

### [Explanation of Processing of Image Generating Apparatus]

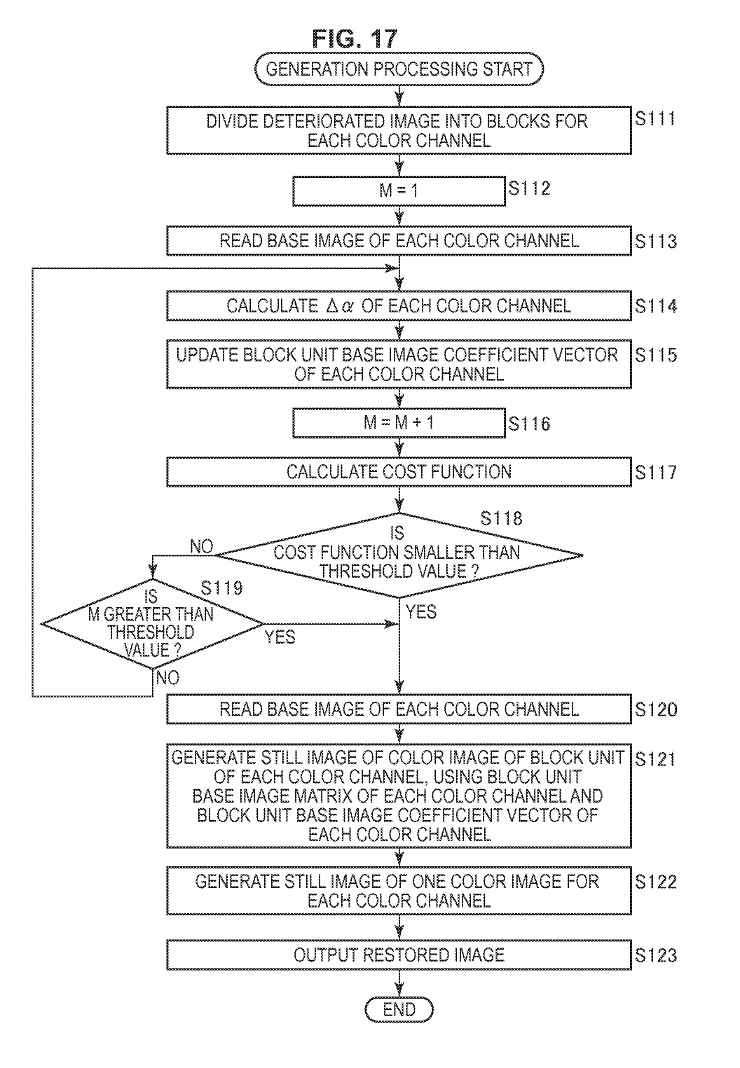

FIG. 17 is a flowchart illustrating generation processing of the image generating apparatus 190 of FIG. 16. The generation processing starts when a still image of a color image of each color channel is input as a deteriorated image from the outside.

In step S111 of FIG. 17, the dividing unit 191 of the image generating apparatus 190 divides the still image of the color image of each color channel input as the deteriorated image from the outside into blocks having predetermined sizes, for each color channel, and supplies the blocks to the operation unit 193, similar to the dividing unit 151 of FIG. 13. Processing of following steps S112 to S121 is executed in the block unit.

In step S112, the operation unit 193 sets the number of times M of repeating the operation of the block unit base image coefficient vector to 1.

In step S113, the operation unit 193 reads the base image of the block unit of each color channel from the storage unit 192.

In step S114, the operation unit 193 calculates Δα using the block unit base image matrix including the read base image of the block unit of each color channel and the blocks of each color channel supplied from the dividing unit 191. Specifically, the operation unit 193 calculates Δα of each color channel by an expression obtained by partially differentiating the cost function defined by the expression 12 with respect to the block unit base image coefficient vector of each color channel and setting Y to the deteriorated image vector, using the block unit base image matrix of each color channel and the blocks of each color channel.

In step S115, the operation unit 193 updates the block unit base image coefficient vector of each color channel by the expression 7, for each color channel, using Δα calculated by step S144. In step S116, the operation unit 193 increments the number of times M of repeating the operation by 1.

In step S117, the operation unit 193 calculates the cost function by an expression obtained by setting Y of the expression 12 to the deteriorated image vector, using the block unit base image coefficient vector of each color channel updated by step S115, the block unit base image matrix of each color channel, and the blocks of each color channel of the deteriorated image.

Because processing of steps S118 and S119 is the same as the processing of steps S48 and S49 of FIG. 17, explanation thereof is omitted.

In step S120, the generating unit 194 reads the base image of the block unit of each color channel from the storage unit 192. In step S121, the generating unit 194 generates the still image of the color image of the block unit of each color channel by an expression obtained by setting the brightness image of the expression 10 to the color image of each color channel, using the block unit base image matrix including the read base image of the block unit of each color channel and the block unit base image coefficient vector of each color channel supplied from the operation unit 193.

In step S122, the generating unit 194 generates a still image of one color image from the still image of the color image of the block unit, for each color channel, according to a block division method. In step S123, the generating unit 194 outputs the generated still image of one brightness image of each color channel as a restored image and ends the processing.

As described above, the image generating apparatus 190 obtains the base images learned by the learning apparatus 150 and operates the base image coefficients, on the basis of the base images, the deteriorated image, and the cost function including the term showing the correspondence between the base image coefficients of the individual color channels as well as the spatial correspondence between the base image coefficients of all the color channels, similar to the case of the learning apparatus 10. Therefore, the image generating apparatus 190 can obtain the base images and the base image coefficients according to the model that is optimized for the human visual system and suppresses false colors from being generated. As a result, the image generating apparatus 190 can generate a high-definition restored image in which the false colors are suppressed from being generated, using the obtained base images and base image coefficients.

In the second embodiment, the cost function may include the term showing only the correspondence between the base image coefficients of the individual color channels. In the second embodiment, base images can be learned while a restored image is generated, similar to the first embodiment. In the second embodiment, the learning image and the deteriorated image may be moving images.

### Third Embodiment

### Configuration Example of Learning Apparatus

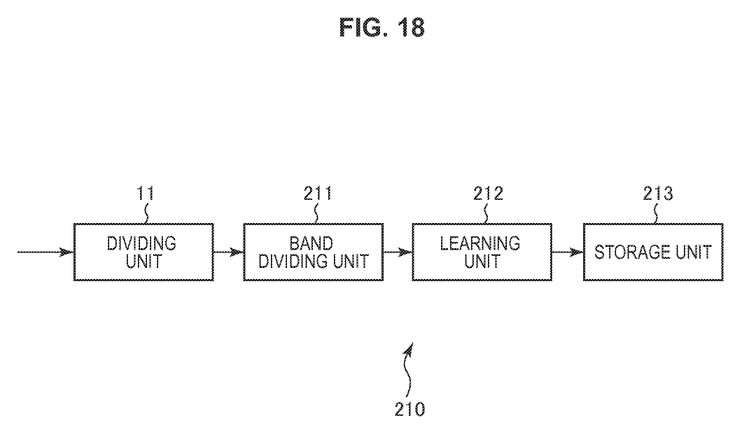

FIG. 18 is a block diagram illustrating a configuration example of a learning apparatus that corresponds to a third embodiment of the signal processing apparatus to which the present disclosure is applied.

Among structural elements illustrated in FIG. 18, the structural elements that are the same as the structural elements of FIG. 2 are denoted with the same reference numerals. Repeated explanation of these structural elements is omitted.

A configuration of a learning apparatus 210 of FIG. 18 is different from the configuration of FIG. 2 in that a band dividing unit 211 is newly provided, a learning unit 212 is provided, instead of the learning unit 12, and a storage unit 213 is provided, instead of the storage unit 13. The learning apparatus 210 learns base images, using a still image of a band divided learning brightness image, such that there is a correspondence between base image coefficients of individual bands and there is a spatial correspondence between the base image coefficients of all the bands.

Specifically, the band dividing unit 211 divides bands of the blocks divided by the dividing unit 11 into a high frequency band (high resolution), an intermediate frequency band (intermediate resolution), and a low frequency band (low resolution), generates the blocks of the high frequency band, the intermediate frequency band, and the low frequency band, and supplies the blocks to the learning unit 212.

The learning unit 212 models the blocks of the high frequency band, the intermediate frequency band, and the low frequency band supplied from the band dividing unit 211 by the expression 1 and learns a base image of a block unit of each band, under a restriction condition in which there is the correspondence between the base image coefficients of the individual bands and there is the spatial correspondence between the base image coefficients of all the bands.

Specifically, the learning unit 212 learns the base image of the block unit of each band, using the blocks of the individual bands and a cost function including a term showing the correspondence between the base image coefficients of the individual bands and the spatial correspondence between the base image coefficients of all the bands. The learning unit 212 supplies the learned base image of the block unit of each band to the storage unit 213 and causes the storage unit 213 to store the base image.

### Configuration Example of Band Dividing Unit

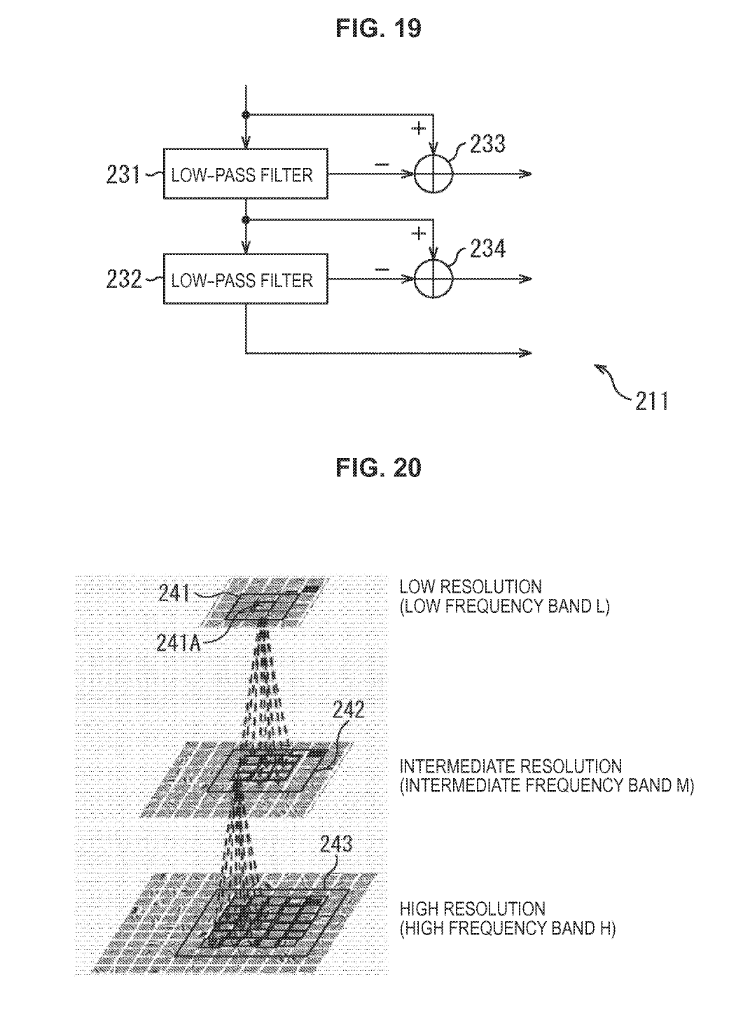

FIG. 19 is a block diagram illustrating a configuration example of the band dividing unit 211 of FIG. 18.

As illustrated in FIG. 19, the band dividing unit 211 includes a low-pass filter 231, a low-pass filter 232, a subtracting unit 233, and a subtracting unit 234.

The blocks that are divided by the dividing unit 11 are input to the low-pass filter 231. The low-pass filter 231 extracts the blocks of the low frequency band among the input blocks and supplies the blocks to the low-pass filter 232, the subtracting unit 233, and the subtracting unit 234.

The low-pass filter 232 extracts the blocks of a further low frequency band among the blocks of the low frequency band supplied from the low-pass filter 231. The low-pass filter 232 supplies the extracted blocks of the low frequency band to the subtracting unit 234 and the learning unit 212 (refer to FIG. 18).

The subtracting unit 233 subtracts the blocks of the low frequency band supplied from the low-pass filter 231 from the blocks input from the dividing unit 11 and supplies the obtained blocks of the high frequency band to the learning unit 212.

The subtracting unit 234 subtracts the blocks of the further low frequency band supplied from the low-pass filter 232, from the blocks of the low frequency band supplied from the low-pass filter 231, and supplies the obtained blocks of the band between the high frequency band and the low frequency band as the blocks of the intermediate frequency band to the learning unit 212.

### [Explanation of Restriction Condition]

FIG. 20 is a diagram illustrating a restriction condition when learning is performed by the learning unit 212 of FIG. 18.

The learning unit 212 learns the base images in which there is the correspondence between the base image coefficients of the individual bands and there is the spatial correspondence between the base image coefficients of all the bands. For this reason, as illustrated in FIG. 20, the learning unit 212 applies a restriction condition in which base image coefficients of a base image 241A of the block unit of the low frequency band, a base image group 241 including 3×3 base images of the block units based on the base image 241A, a base image group 242 including 3×3 base images of the block units of the intermediate frequency band corresponding to the base images of the base image group 241, and a base image group 243 including 5×6 base images of the block units of the high frequency band corresponding to the base images of the base image group 241 have the same sparse representation, when a cost function is operated.

Specifically, the learning unit 212 defines the cost function by the following expression 13.

$$L = argmin \{ {‖ {D}^{H} {α}^{H} - H ‖}^{2} + {‖ {D}^{M} {α}^{M} - M ‖}^{2} + {‖ {D}^{L} {α}^{L} - Lo ‖}^{2} + {μ}_{1} {Σ}_{i} F ( {Σ}_{j} h ( i , j ) ( {α}_{j}^{L 2} + {Σ}_{k} h ( i , j , k ) ( {α}_{k}^{M 2} + {Σ}_{m} h ( i , j , k , m ) + {α}_{m}^{H 2} ) ) ) + {μ}_{2} {Σ}_{i} F ( {Σ}_{j} h ( i , j ) ( {α}_{j}^{M 2} + {Σ}_{k} h ( i , j , k ) {α}_{k}^{H 2} ) ) + {μ}_{3} {Σ}_{i} F ( {Σ}_{j} h ( i , j ) {α}_{j}^{H 2} ) ] \\ F ( y ) = a \sqrt{y + b} \qquad ( 13 )$$

In the expression 13, D^{H}, D^{M}, and D^{L} denote block unit base image matrixes of the high frequency band, the intermediate frequency band, and the low frequency band, respectively, and α^{H}, α^{M}, and α^{L} denote block unit base image coefficient vectors of the high frequency band, the intermediate frequency band, and the low frequency band, respectively. In addition, H, M, and Lo denote learning brightness image vectors of the high frequency band, the intermediate frequency band, and the low frequency band, respectively, and μ₁ to μ₃ denote previously set parameters.

In addition, h(i, j) denotes a correspondence coefficient. In addition, h(i, j, k) denotes a coefficient that shows a correspondence relation of a base image coefficient of an i-th (i=1, . . . , and n (base image number)) base image of a block unit of a predetermined band, a base image coefficient of a j-th (j=1, . . . , and 9) base image of the block unit among 3×3 base images of the block units based on the i-th base image of the block unit of the predetermined band, and a base image coefficient of a k-th base image of the block unit among base images of the block units of the bands higher than the predetermined band, corresponding to the i-th base image of the block unit of the predetermined band.

In addition, h(i, j, k, m) denotes a coefficient that shows a correspondence relation of a base image coefficient of an i-th (i=1, . . . , and n (base image number)) base image of the block unit of the low frequency band, a base image coefficient of a j-th (j=1, . . . , and 9) base image of the block unit among 3×3 base images of the block units based on the i-th base image of the block unit of the low frequency band, a base image coefficient of a k-th (k=1, . . . , and 9) base image of the block unit among 3×3 base images of the intermediate frequency band corresponding to the i-th base image of the block unit of the low frequency band, and a base image coefficient of an m-th (m=1, . . . , and 30) base image of the block unit among 5×6 base images of the high frequency band corresponding to the i-th base image of the block unit of the low frequency band.

In addition, α^{L}ⱼ, α^{M}ⱼ, and α^{H}ⱼ denote base image coefficients of j-th (j=1, . . . , and 9) base images of the block units among the 3×3 base images of the block units based on the i-th (i=1, . . . , and n (base image number)) base images of the block units of the low frequency band, the intermediate frequency band, and the high frequency band, respectively. In addition, α^{M}ₖ and α^{H}ₖ denote base image coefficients of the k-th base images of the block units among the base images of the block units of higher bands (the intermediate frequency band and the high frequency band), corresponding to the i-th (i=1, . . . , and n (base image number)) base images of the block units of the low frequency band and the intermediate frequency band, respectively.

In addition, α^{H}ₘ denotes a base image coefficient of an m-th (m=1, . . . , and 30) base image of the block unit among 5×6 base images of the block units of the high frequency band corresponding to the i-th (i=1, . . . , and n (base image number)) base image of the block unit of the low frequency band. In addition, a, y, and b denote previously set parameters. Therefore, a fourth term and a fifth term in argmin ( ) of the right side of the expression 13 are terms that show the correspondence between the base image coefficients of the individual bands.

### [Explanation of Processing of Learning Apparatus]

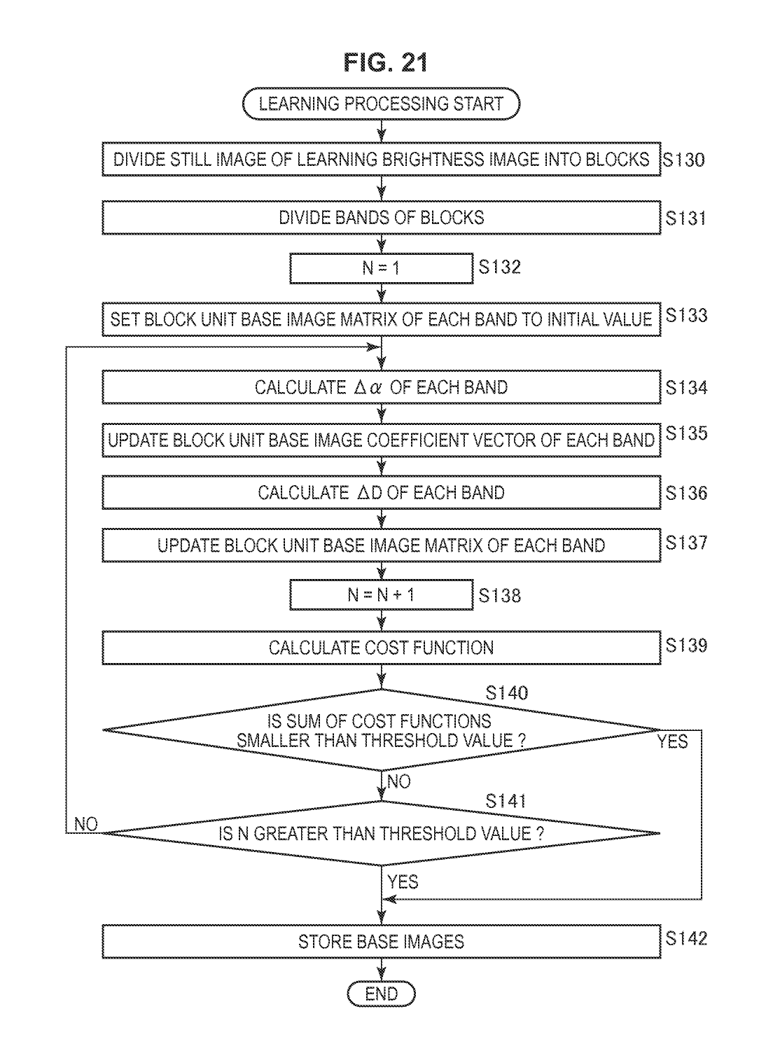

FIG. 21 is a flowchart illustrating learning processing of the learning apparatus 210 of FIG. 18. The learning processing is performed off-line when the still images of all the learning brightness images are input from the outside to the learning apparatus 210.

In step S130 of FIG. 21, the dividing unit 11 divides the still image of the learning brightness image input from the outside into the blocks having the predetermined sizes and supplies the blocks to the band dividing unit 211. In step S131, the band dividing unit 211 divides the bands of the blocks supplied from the dividing unit 11 into the high frequency band, the intermediate frequency band, and the low frequency band and supplies the blocks to the learning unit 212.

Processing of steps S132 to S142 is the same as the processing of steps S92 to S102 of FIG. 15, except that the color channel changes to the band and the expression defining the cost function is the expression 13, not the expression 12. Therefore, explanation of the processing is omitted.

As described above, the cost function in the learning apparatus 210 includes the term showing the correspondence between the base image coefficients of the individual bands as well as the spatial correspondence between the base image coefficients of all the bands, similar to the case of the learning apparatus 10. Therefore, base images can be learned using a model that is optimized for the human visual system and improves an image quality of an important portion such as a texture or an edge. As a result, accurate base images can be learned.

### Configuration Example of Image Generating Apparatus

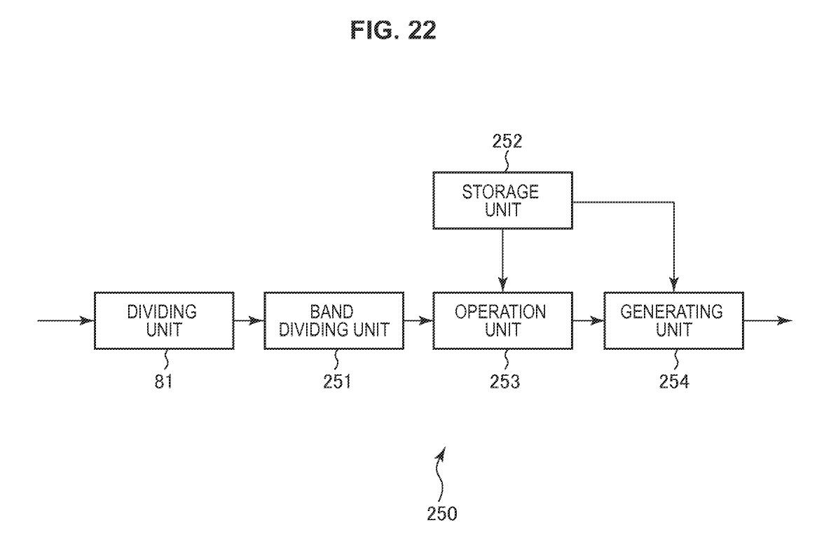

FIG. 22 is a block diagram illustrating a configuration example of an image generating apparatus that generates an image using the base image of each band learned by the learning apparatus 210 of FIG. 18 and corresponds to a third embodiment of the output apparatus to which the present disclosure is applied.

Among structural elements illustrated in FIG. 22, the structural elements that are the same as the structural elements of FIG. 8 are denoted with the same reference numerals. Repeated explanation of these structural elements is omitted.

A configuration of an image generating apparatus 250 of FIG. 22 is different from the configuration of FIG. 8 in that a band dividing unit 251 is newly provided and a storage unit 252, an operation unit 253, and a generating unit 254 are provided, instead of the storage unit 82, the operation unit 83, and the generating unit 84. The image generating apparatus 250 performs sparse coding with respect to a still image of a brightness image input as a deteriorated image from the outside, for each band, and generates a restored image.

Specifically, the band dividing unit 251 of the image generating apparatus 250 has the same configuration as the band dividing unit 211 of FIG. 19. The band dividing unit 251 divides the bands of the blocks divided by the dividing unit 81 into the high frequency band, the intermediate frequency band, and the low frequency band and supplies the blocks to the operation unit 253.

The storage unit 252 stores a base image of a block unit of each band that is learned by the learning apparatus 210 of FIG. 18 and is stored in the storage unit 213.

The operation unit 253 reads the base image of the block unit of each band from the storage unit 252. The operation unit 253 operates the block unit base image coefficient vector of each band, for each block of the deteriorated image supplied from the band dividing unit 251, such that the cost function becomes smaller than the predetermined threshold value. The cost function is defined by an expression obtained by setting H, M, and Lo of the expression 13 to deteriorated image vectors of the high frequency band, the intermediate frequency band, and the low frequency band, respectively, using the block unit base image matrix including the read base image of the block unit of each band. The operation unit 253 supplies the block unit base image coefficient vector of each band to the generating unit 254.

The generating unit 254 reads the base image of the block unit of each band from the storage unit 252. The generating unit 254 generates the still image of the brightness image by the expression 10, for each block of each band, using the block unit base image coefficient vector of each band supplied from the operation unit 253 and the block unit base image matrix including the read base image of the block unit of each band.

The generating unit 254 synthesizes the still image of the brightness image of the block of each band, generates the still image of one brightness image of all the bands, and outputs the still image as a restored image.

### Configuration Example of Generating Unit

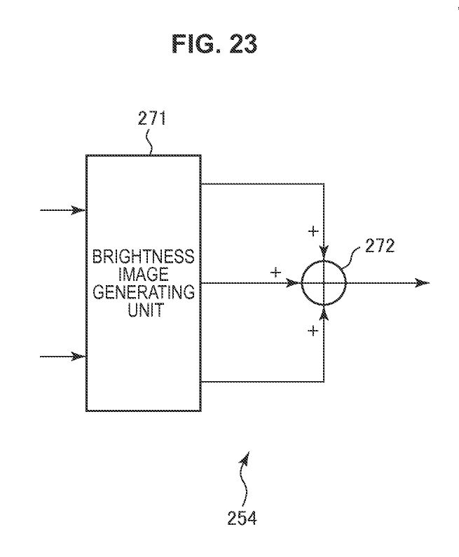

FIG. 23 is a block diagram illustrating a configuration example of the generating unit 254 of FIG. 22.

The generating unit 254 of FIG. 23 includes a brightness image generating unit 271 and an adding unit 272.

The brightness image generating unit 271 of the generating unit 254 reads a base image of a block unit of each band from the storage unit 252 of FIG. 22. The brightness mage generating unit 271 generates a still image of a brightness image by the expression 10, for each block of each band, using the block unit base image coefficient vector of each band supplied from the operation unit 253 and the block unit base image matrix including the read base image of the block unit of each band.

The brightness image generating unit 271 synthesizes the still image of the brightness image of the block unit of each block, for each band, and generates a still image of one brightness image of each band. The brightness image generating unit 271 supplies the generated still image of one brightness image of the high frequency band, the intermediate frequency band, and the low frequency band to the adding unit 272.

The adding unit 272 adds the still image of one brightness image of the high frequency band, the intermediate frequency band, and the low frequency band supplied from the brightness image generating unit 271 and outputs a still image of one brightness image of all the bands obtained as an addition result as a restored image.

### [Explanation of Processing of Image Generating Apparatus]

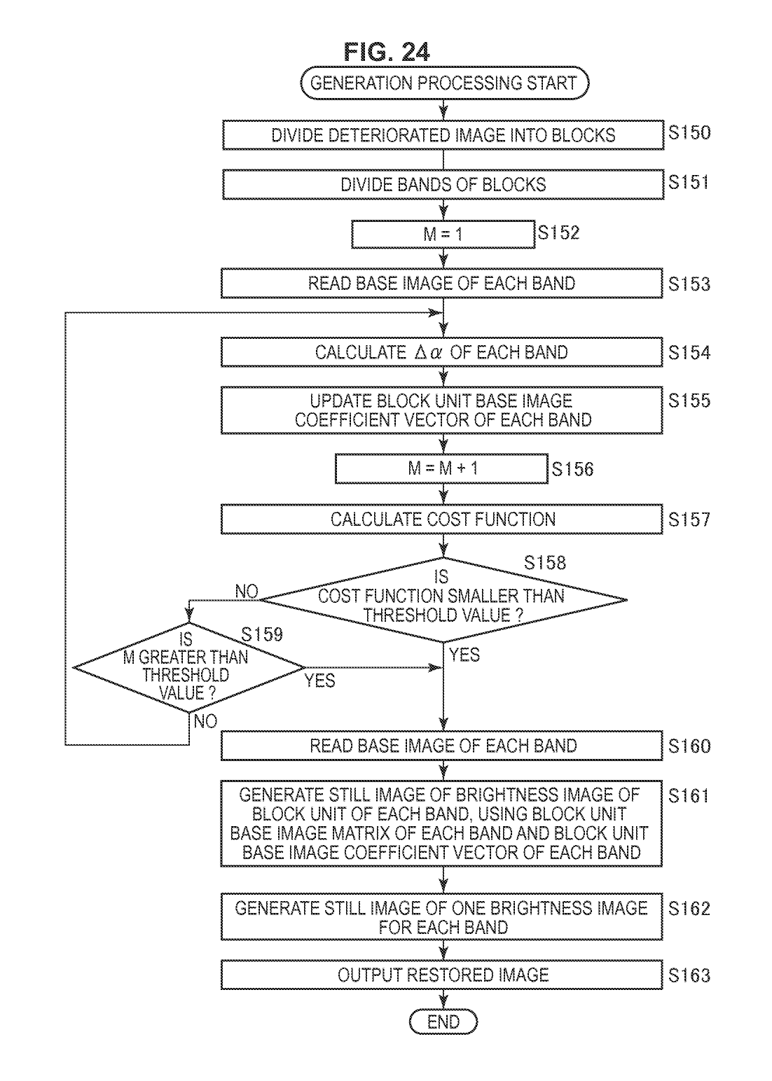

FIG. 24 is a flowchart illustrating generation processing of the image generating apparatus 250 of FIG. 22. The generation processing starts when a still image of a brightness image is input as a deteriorated image from the outside.

In step S150 of FIG. 24, the dividing unit 81 divides the still image of the brightness image input as the deteriorated image from the outside into blocks having predetermined sizes and supplies the blocks to the band dividing unit 251, similar to the dividing unit 11 of FIG. 18. In step S151, the band dividing unit 251 divides the bands of the blocks supplied from the dividing unit 81 into the high frequency band, the intermediate frequency band, and the low frequency band and supplies the blocks to the operation unit 253.

Processing of steps S152 to S163 is the same as the processing of steps S112 to S123 of FIG. 17, except that the color channel changes to the band and the expression defining the cost function is an expression obtained by setting H, M, and Lo of the expression 13 to the deteriorated image vectors of the high frequency band, the intermediate frequency band, and the low frequency band, not the expression 12. Therefore, explanation of the processing is omitted.

As described above, the image generating apparatus 250 obtains the base images learned by the learning apparatus 210 and operates the base image coefficients on the basis of the base images, the deteriorated image, and the cost function including the term showing the correspondence between the base image coefficients of the individual bands as well as the spatial correspondence between the base image coefficients of all the bands, similar to the case of the learning apparatus 10. Therefore, the image generating apparatus 250 can obtain the base images and the base image coefficients according to the model that is optimized for the human visual system and improves an image quality of an important portion such as a texture or an edge. As a result, the image generating apparatus 250 can generate a high-definition restored image in which the image quality of the important portion such as the texture or the edge is improved, using the obtained base images and base image coefficients.

In the third embodiment, the cost function may include the term showing only the correspondence between the base image coefficients of the individual bands. In the third embodiment, base images can be learned while a restored image is generated, similar to the first embodiment.

In the third embodiment, the bands of the still image of the brightness image are divided into the three bands of the high frequency band, the intermediate frequency band, and the low frequency band. However, the band division number is not limited to 3. The passage band of the low-pass filter 231 (232) is not limited.

In the third embodiment, the learning image and the deteriorated image are the still images of the brightness images. However, the learning image and the deteriorated image may be the still images of the color images. In this case, learning processing or generation processing is executed for each color channel. The learning image and the deteriorated image may be moving images.

### Fourth Embodiment

### Configuration Example of Learning Apparatus

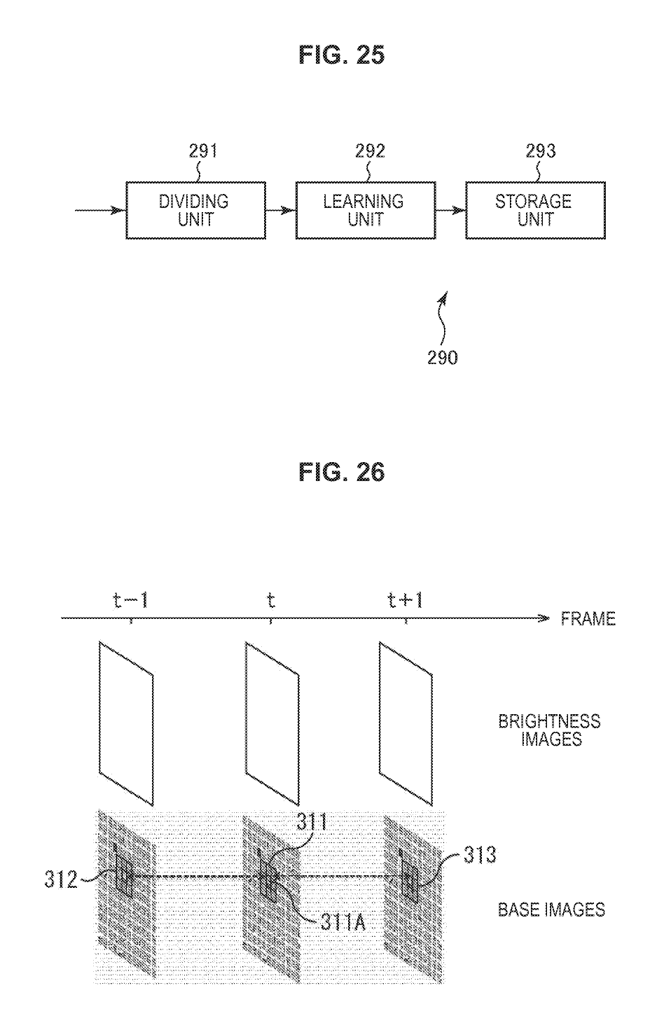

FIG. 25 is a block diagram illustrating a configuration example of a learning apparatus that corresponds to a fourth embodiment of the signal processing apparatus to which the present disclosure is applied.

A learning apparatus 290 of FIG. 25 includes a dividing unit 291, a learning unit 292, and a storage unit 293. The learning apparatus 290 learns base images using a moving image of a learning brightness image, such that there are a temporal correspondence and a spatial correspondence between base image coefficients of three continuous frames.

Specifically, moving images of a large amount of learning brightness images that do not have image quality deterioration are input from the outside to the dividing unit 291. The dividing unit 291 divides the moving image of the learning brightness image into blocks having predetermined sizes, for each frame, and supplies the blocks to the learning unit 292.

The learning unit 292 models the blocks of the individual frames supplied from the dividing unit 291 by the expression 1 described above and learns a base image of a block unit of each frame of three continuous frames, under a restriction condition in which there are the temporal correspondence and the spatial correspondence between the base image coefficients of the three continuous frames.

Specifically, the learning unit 292 learns the base image of the block unit of each frame of the three continuous frames, using the blocks of each frame of the three continuous frames and a cost function including a term showing the temporal correspondence and the spatial correspondence between the base image coefficients of the three continuous frames. The learning unit 292 supplies the learned base image of the block unit of each frame of the three continuous frames to the storage unit 293 and causes the storage unit 293 to store the base image.

### [Explanation of Restriction Condition]

FIG. 26 is a diagram illustrating a restriction condition when learning is performed by the learning unit 292 of FIG. 25.

In FIG. 26, a horizontal axis shows a frame number from a head.

The learning unit 292 learns base images in which there is the correspondence between the base image coefficients of the individual frames of the three continuous frames and there is the spatial correspondence between the base image coefficients of the three continuous frames. For this reason, as illustrated in FIG. 26, the learning unit 292 applies a restriction condition in which base image coefficients of a base image 311A of a block unit of a t-th (t=1, 2, . . . , and T/3 (frame number of a moving image) frame, a base image group 311 including 3×3 base images of the block units based on the base image 311A, a base image group 312 of a (t−1)-th frame at the same position as the base image group 311, and a base image group 313 of a (t+1)-th frame at the same position as the base image group 311 have the same sparse representation, when a cost function is operated.

Specifically, the learning unit 292 defines the cost function by the following expression 14.

L=argminΣₜ{∥D^{t-1}α^{t-1}−Y^{t-1}∥²+∥D^{t}α^{t}−Y^{t}∥²+∥D^{t+1}α^{t+1}−Y^{t+1}∥²

+μΣᵢF(Σⱼh(i,j)α^{t-1}ⱼ²+α^{t}ⱼ²+α^{t+1}ⱼ²))}

F(y)=a\sqrt{y}+b (14)

In the expression 14, D^{t-1}, D^{t}, and D^{t+1} denote block unit base image matrixes of the (t−1)-th frame, the t-th frame, and the (t+1)-th frame, respectively, and α^{t-1}, α^{t}, and α^{t+1} denote block unit base image coefficient vectors of the (t−1)-th frame, the t-th frame, and the (t+1)-th frame, respectively. In addition, Y^{t-1}, Y^{t}, and Y^{t+1} denote learning brightness image vectors of the (t−1)-th frame, the t-th frame, and the (t+1)-th frame, respectively, and p denotes a previously set parameter. In addition, h(i, j) denotes a correspondence coefficient.

In addition, α^{t-1}ⱼ, α^{t}ⱼ, and α^{t+1}ⱼ denote base image coefficients of j-th (j=1, . . . , and 9) base images of block units among 3×3 base images of the block units based on i-th (i=1, . . . , and n (base image number)) base images of the block units of the (t−1)-th frame, the t-th frame, and the (t+1)-th frame, respectively. In addition, a, y, and b denote previously set parameters.

Therefore, a fourth term in argmin ( ) of the right side of the expression 14 is a term that shows the temporal correspondence and the spatial correspondence between the base image coefficients of the three continuous frames.

### [Explanation of Processing of Learning Apparatus]

Learning processing of the learning apparatus 290 is the same as the learning processing of FIG. 15, except that each color channel changes to each frame of the three continuous frames and the expression defining the cost function is the expression 14, not the expression 12. Therefore, illustration and explanation of the learning processing are omitted.

As described above, the cost function in the learning apparatus 290 includes the term showing the temporal correspondence between the base image coefficients of the three continuous frames as well as the spatial correspondence between the base image coefficients of the three continuous frames, similar to the case of the learning apparatus 10. Therefore, base images can be learned using a model that is optimized for the human visual system and decreases fluttering between the frames to smooth a moving image. As a result, accurate base images can be learned.

### Configuration Example of Image Generating Apparatus

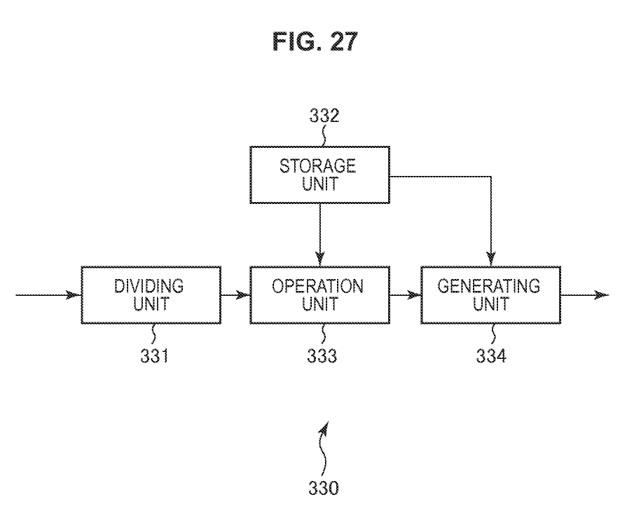

FIG. 27 is a block diagram illustrating a configuration example of an image generating apparatus that generates an image using the base image of each frame of the three continuous frames learned by the learning apparatus 290 of FIG. 25 and corresponds to a fourth embodiment of the output apparatus to which the present disclosure is applied.

An image generating apparatus 330 of FIG. 27 includes a dividing unit 331, a storage unit 332, an operation unit 333, and a generating unit 334. The image generating apparatus 330 performs sparse coding with respect to a moving image of a brightness image input as a deteriorated image from the outside and generates a restored image.

Specifically, the moving image of the brightness image is input as the deteriorated image from the outside to the dividing unit 331 of the image generating apparatus 330. The dividing unit 331 divides the deteriorated image input from the outside into blocks having predetermined sizes, for each frame, and supplies the blocks to the operation unit 333, similar to the dividing unit 291 of FIG. 25.

The storage unit 332 stores the base image of the block unit of each frame of the three continuous frames that is learned by the learning apparatus 290 of FIG. 25 and is stored in the storage unit 293.

The operation unit 333 reads the base image of the block unit of each frame of the three continuous frames from the storage unit 332. The operation unit 333 operates the block unit base image coefficient vector of each frame, for each block of the deteriorated image corresponding to the three frames supplied from the dividing unit 331, such that the cost function becomes smaller than the predetermined threshold value. The cost function is defined by an expression obtained by setting Y^{t-1}, Y^{t}, and Y^{t+1} of the expression 14 to deteriorated image vectors of the (t−1)-th frame, the t-th frame, and the (t+1)-th frame, using the block unit base image matrix including the read base image of the block unit of each frame of the three continuous frames. The operation unit 333 supplies the block unit base image coefficient vector of each frame of the three continuous frames to the generating unit 334.

The generating unit 334 reads the base image of the block unit of each frame of the three continuous frames from the storage unit 332. The generating unit 334 generates the moving image of the brightness image by the expression 10, for each block of each frame of the three continuous frames, using the block unit base image coefficient vector of each frame of the three continuous frames supplied from the operation unit 333 and the block unit base image matrix including the read base image of the block unit of each frame of the three continuous frames.

The generating unit 334 generates a moving image of the brightness image of the three continuous frames from the moving image of the brightness image of the block of each frame of the three continuous frames and outputs the moving image as a restored image of the three continuous frames.

### [Explanation of Processing of Image Generating Apparatus]

Generation processing of the image generating apparatus 330 of FIG. 27 is the same as the generation processing of FIG. 17, except that each color channel changes to each frame of the three continuous frames and the expression defining the cost function is the expression obtained by setting Y^{t-1}, Y^{t}, and Y^{t+1} of the expression 14 to deteriorated image vectors of the (t−1)-th frame, the t-th frame, and the (t+1)-th frame, not the expression 12. Therefore, illustration and explanation of the generation processing are omitted.

As described above, the image generating apparatus 330 obtains the base images learned by the learning apparatus 290 and operates the base image coefficients on the basis of the base images, the deteriorated image, and the cost function including the term showing the temporal correspondence between the base image coefficients of the three continuous frames as well as the spatial correspondence between the base image coefficients of the three continuous frames, similar to the case of the learning apparatus 10. Therefore, the image generating apparatus 330 can obtain the base images and the base image coefficients according to the model that is optimized for the human visual system and decreases fluttering between the frames to smooth a moving image. As a result, the image generating apparatus 330 can generate a high-definition restored image in which the fluttering between the frames is decreased, using the obtained base images and base image coefficients.

In the fourth embodiment, the cost function may include the term showing only the temporal correspondence between the base image coefficients of the three continuous frames. In the fourth embodiment, base images can be learned while a restored image is generated, similar to the first embodiment.

In the fourth embodiment, the learning image and the deteriorated image may be moving images of the brightness images. However, the learning image and the deteriorated image may be the moving images of the color images.

In this case, each frame of the moving image of the color image is divided into the blocks having the predetermined sizes, for each color channel. In addition, the cost function is defined for each color channel. As a result, the learning apparatus 290 learns the base image of the block unit of each frame of the three continuous frames, for each color channel, and the image generating apparatus 330 generates the moving image of the color image, for each color channel.

In the fourth embodiment, there is the temporal correspondence between the base image coefficients of the three continuous frames. However, the frame number of the base image coefficients that have the temporal correspondence is not limited to 3.

### Fifth Embodiment

### Configuration Example of Learning Apparatus

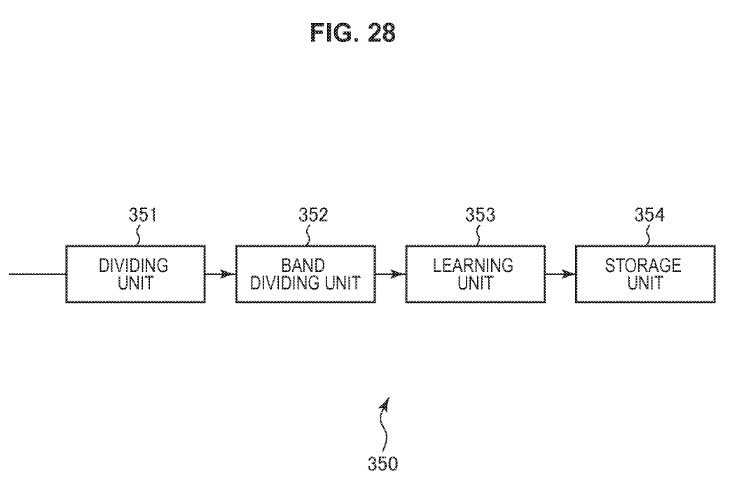

FIG. 28 is a block diagram illustrating a configuration example of a learning apparatus that corresponds to a fifth embodiment of the signal processing apparatus to which the present disclosure is applied.

A learning apparatus 350 of FIG. 28 includes a dividing unit 351, a band dividing unit 352, a learning unit 353, and a storage unit 354. The learning apparatus 350 learns a base audio signal, using a band divided learning audio signal, such that there is a correspondence between base audio coefficients of individual bands and there is a spatial correspondence between the base audio coefficients of all the bands.

Specifically, a large amount of learning audio signals that do not have large sound quality deterioration are input from the outside to the dividing unit 351. The dividing unit 351 divides the learning audio signal into blocks (frames) of predetermined sections and supplies the blocks to the band dividing unit 352.

The band dividing unit 352 has the same configuration as the band dividing unit 211 of FIG. 19. The band dividing unit 352 divides bands of blocks supplied from the dividing unit 351 into a high frequency band, an intermediate frequency band, and a low frequency band and supplies the blocks to the learning unit 353.

The learning unit 353 models the blocks of the high frequency band, the intermediate frequency band, and the low frequency band supplied from the band dividing unit 352 by an expression obtained by setting the image of the expression 1 to the audio signal and learns a base audio signal of a block unit of each band, under a restriction condition in which there is a correspondence between base audio coefficients (which will be described in detail below) of the individual bands and there is a spatial correspondence between the base audio coefficients of all the bands.

Specifically, the learning unit 353 learns the base audio signal of the block unit of each band, using the blocks of the individual bands and a cost function including a term showing the correspondence between the base audio coefficients of the individual bands and the spatial correspondence between the base audio coefficients of all the bands. The cost function is defined by the expression obtained by setting the image of the expression 13 to the audio signal.

That is, in the expression that defines the cost function in the learning unit 353, D^{H}, D^{M}, and D^{L} denote matrixes (hereinafter, referred to as block unit base audio matrixes) in which arrangements of individual sampling values of base audio signals of block units of the high frequency band, the intermediate frequency band, and the low frequency band in a column direction are arranged in a row direction for each base audio signal, respectively. In addition, α^{H}, α^{M}, and α^{L} denote vectors (hereinafter, referred to as block unit base audio coefficient vectors) in which base audio coefficients to be coefficients of base audio signals of block units of the high frequency band, the intermediate frequency band, and the low frequency band are arranged in the column direction, respectively. In addition, H, M, and Lo denote vectors (hereinafter, referred to as learning voice vectors) in which sampling values of learning audio signals of the high frequency band, the intermediate frequency band, and the low frequency band are arranged in the column direction, respectively, and μ₁ to μ₃ denote previously set parameters.

In addition, h(i, j) denotes a coefficient that shows a correspondence relation of a base audio coefficient of an i-th (i=1, . . . , and n (base audio signal number)) base audio signal of the block unit and a base audio coefficient of a j-th (j=1, . . . , and 9) base audio signal of the block unit among 3×3 base audio signals of the block units based on the i-th base audio signal of the block unit. In addition, h(i, j, k) denotes a coefficient that shows a correspondence relation of a base audio coefficient of an i-th (i=1, . . . , and n (base audio signal number)) base audio signal of a block unit of a predetermined band, a base audio coefficient of a j-th (j=1, . . . , and 9) base audio signal of the block unit among 3×3 base audio signals of the block units based on the i-th base audio signal of the block unit of the predetermined band, and a base audio coefficient of a k-th base audio signal of the block unit among base audio signals of the block units of bands higher than the predetermined band, corresponding to the i-th base audio signal of the block unit of the predetermined band.

In addition, h(i, j, k, m) denotes a coefficient that shows a correspondence relation of a base audio coefficient of an i-th (i=1, . . . , and n (base audio signal number)) base audio signal of a block unit of a low frequency band, a base audio coefficient of a j-th (j=1, . . . , and 9) base audio signal of the block unit among 3×3 base audio signals of the block units based on the i-th base audio signal of the block unit of the low frequency band, a base audio coefficient of a k-th (k=1, . . . , and 9) base audio signal of the block unit among 3×3 base audio signals of an intermediate frequency band corresponding to the i-th base audio signal of the block unit of the low frequency band, and a base image coefficient of an m-th (m=1, . . . , and 30) base audio signal of the block unit among 5×6 base audio signals of a high frequency band corresponding to the i-th base audio signal of the block unit of the low frequency band.

In addition, α^{L}ⱼ, α^{M}ⱼ, and α^{H}ⱼ denote base audio coefficients of j-th (j=1, . . . , and 9) base audio signals of the block units among the 3×3 base audio signals of the block units based on the i-th (i=1, . . . , and n (base audio signal number)) base audio signals of the block units of the low frequency band, the intermediate frequency band, and the high frequency band, respectively. In addition, α^{M}ₖ and α^{H}ₖ denote base audio coefficients of the k-th base audio signals of the block units among the base audio signals of the block units of higher bands (the intermediate frequency band and the high frequency band), corresponding to the i-th (i=1, . . . , and n (base audio signal number)) base audio signals of the block units of the low frequency band and the intermediate frequency band, respectively.

In addition, α^{H}ₘ denotes a base audio coefficient of an m-th (m=1, . . . , and 30) base audio signal of the block unit among 5×6 base audio signals of block units of a high frequency band corresponding to the i-th (i=1, . . . , and n (base audio signal number)) base audio signal of the block unit of the low frequency band. In addition, a, y, and b denote previously set parameters.

The learning unit 353 supplies the learned base audio signal of the block unit of each band to the storage unit 354 and causes the storage unit 354 to store the base audio signal.

### [Explanation of Processing of Learning Apparatus]

The learning processing of the learning apparatus 350 is the same as the learning processing of FIG. 21, except that the learning signal is the audio signal, not the still image of the brightness image, and the cost function is the expression obtained by setting the image of the expression 13 to the audio signal. Therefore, illustration and explanation of the learning processing are omitted.

As described above, the learning apparatus 350 learns the base audio signal using the cost function including the term showing the spatial correspondence between the base audio coefficients, such that the learning audio signal is represented by a linear operation of the base audio signal of which the base audio coefficient becomes sparse. Therefore, the learning apparatus 350 can learn the base audio signal using the model optimized for the human visual system. In this case, human visual and auditory systems are systems that execute processing of brains understanding a signal input from the outside and execute the same processing. Therefore, the learning apparatus 350 can learn the base audio signal using the model optimized for the human visual system. As a result, accurate base audio signals can be learned.

### Configuration Example of Audio Generating Apparatus

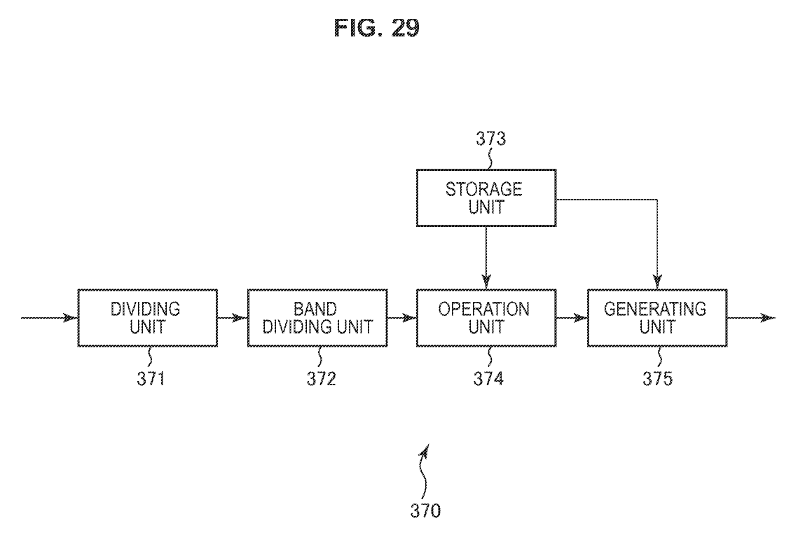

FIG. 29 is a block diagram illustrating a configuration example of an audio generating apparatus that generates an audio signal using the base audio signal of each band learned by the learning apparatus 350 of FIG. 28 and corresponds to a fifth embodiment of the output apparatus to which the present disclosure is applied.

An audio generating apparatus 370 of FIG. 29 includes a dividing unit 371, a band dividing unit 372, a storage unit 373, an operation unit 374, and a generating unit 375. The audio generating apparatus 370 performs sparse coding with respect to a sound quality deteriorated deterioration audio signal input from the outside, for each band, and generates a restoration audio signal.

The deterioration audio signal is input from the outside to the dividing unit 371 of the audio generating apparatus 370. The dividing unit 371 divides the deterioration audio signal input from the outside into blocks of predetermined sections and supplies the blocks to the band dividing unit 372, similar to the dividing unit 351 of FIG. 28.

The band dividing unit 372 has the same configuration as the band dividing unit 352 of FIG. 28. The band dividing unit 372 divides bands of the blocks supplied from the dividing unit 371 into a high frequency band, an intermediate frequency band, and a low frequency band and supplies the blocks to the operation unit 374.

The storage unit 373 stores a base audio signal of a block unit of each band that is learned by the learning apparatus 350 of FIG. 28 and is stored in the storage unit 354.

The operation unit 374 reads the base audio signal of the block unit of each band from the storage unit 373. The operation unit 374 operates a block unit base audio coefficient vector of each band, for each block of the deterioration audio signal supplied from the band dividing unit 372, such that the cost function becomes smaller than the predetermined threshold value. The cost function is defined by an expression obtained by setting H, M, and Lo of the expression 13 to vectors (hereinafter, referred to as deterioration audio vectors) in which sampling values of the blocks of the deterioration audio signals of the high frequency band, the intermediate frequency band, and the low frequency band are arranged in a column direction, using the block unit base audio matrix including the read base audio signal of the block unit of each band. The operation unit 374 supplies the block unit base audio coefficient vector of each band to the generating unit 375.

The generating unit 375 reads the base audio signal of the block unit of each band from the storage unit 373. The generating unit 375 generates the audio signal by an expression obtained by setting the image of the expression 10 to the audio signal, for each block of each band, using the block unit base audio coefficient vector of each band supplied from the operation unit 374 and the block unit base audio matrix including the read base audio signal of the block unit of each band.

The generating unit 375 synthesizes the audio signal of the block of each band, generates an audio signal of all the bands of all of the sections, and outputs the audio signal as a restoration audio signal.

### [Explanation of Processing of Audio Generating Apparatus]

The generation processing of the audio generating apparatus 370 is the same as the generation processing of FIG. 24, except that the signal becoming the sparse coding object is the deterioration audio signal, not the deteriorated image, and the cost function is calculated by an expression obtained by setting the image of the expression 13 to the audio signal and setting H, M, and Lo to the deterioration audio vectors of the high frequency band, the intermediate frequency band, and the low frequency band. Therefore, illustration and explanation of the generation processing are omitted.

As described above, the audio generating apparatus 370 obtains the base audio signal learned by the learning apparatus 350 and operates the base audio coefficients on the basis of the base audio signal, the deterioration audio signal, and the cost function including the term showing the spatial correspondence between the base audio coefficients. Therefore, the audio generating apparatus 370 can obtain the base audio images and the base audio coefficients according to the model that is optimized for the human visual system. As described above, the human visual and auditory systems are the systems that execute the same processing. Therefore, the audio generating apparatus 370 can obtain the base audio signals and the base audio coefficients according to the model that is optimized for the human auditory system. As a result, the audio generating apparatus 370 can generate a restoration audio signal having a high sound quality, using the obtained base audio signals and base audio coefficients.

In the fifth embodiment, the cost function that includes the term showing the correspondence between the base audio coefficients of the individual bands as well as the spatial correspondence between the base audio coefficients of all the bands is used. However, the cost function that includes the term showing only the spatial correspondence between the base audio coefficients of all the bands may be used.

### Sixth Embodiment

### Configuration Example of Learning Apparatus

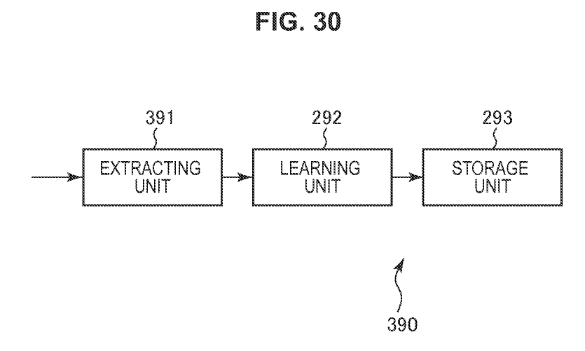

FIG. 30 is a block diagram illustrating a configuration example of a learning apparatus that corresponds to a sixth embodiment of the signal processing apparatus to which the present disclosure is applied.

Among structural elements illustrated in FIG. 30, the structural elements that are the same as the structural elements of FIG. 25 are denoted with the same reference numerals. Repeated explanation of these structural elements is omitted.

A configuration of a learning apparatus 390 of FIG. 30 is different from the configuration of FIG. 25 in that an extracting unit 391 is provided, instead of the dividing unit 291. Moving images of a large amount of normal brightness images imaged by a monitoring camera not illustrated in the drawings are input as moving images of learning brightness images to the learning apparatus 390.

The extracting unit 391 of the learning apparatus 390 extracts an abnormality detection object region (hereinafter, referred to as a detection region) by an abnormality detecting apparatus to be described below, from each frame of the moving images of the large amount of normal brightness images input by the monitoring camera by the moving images of the learning brightness images.

For example, when the abnormality detecting apparatus to be described below detects abnormality of a person, the extracting unit 391 detects a region of the person or a face and extracts the region as the detection region. When the abnormality detecting apparatus to be described below detects abnormality of a vehicle, the extracting unit 391 detects a region including a previously set feature point of the vehicle and extracts the region as the detection region. The extracting unit 391 extracts the detection region for every frames of a predetermined number, not every frame. During a period in which the detection region is not extracted, the extracting unit 391 may track the extracted detection region and set the detection region.

The extracting unit 391 normalizes the extracted detection region, forms blocks having predetermined sizes, and supplies the blocks to the learning unit 292.

The number of detection regions may be singular or plural for each frame. When the number of detection regions of each frame is plural, the base image is learned for each detection region.

### [Explanation of Processing of Learning Apparatus]

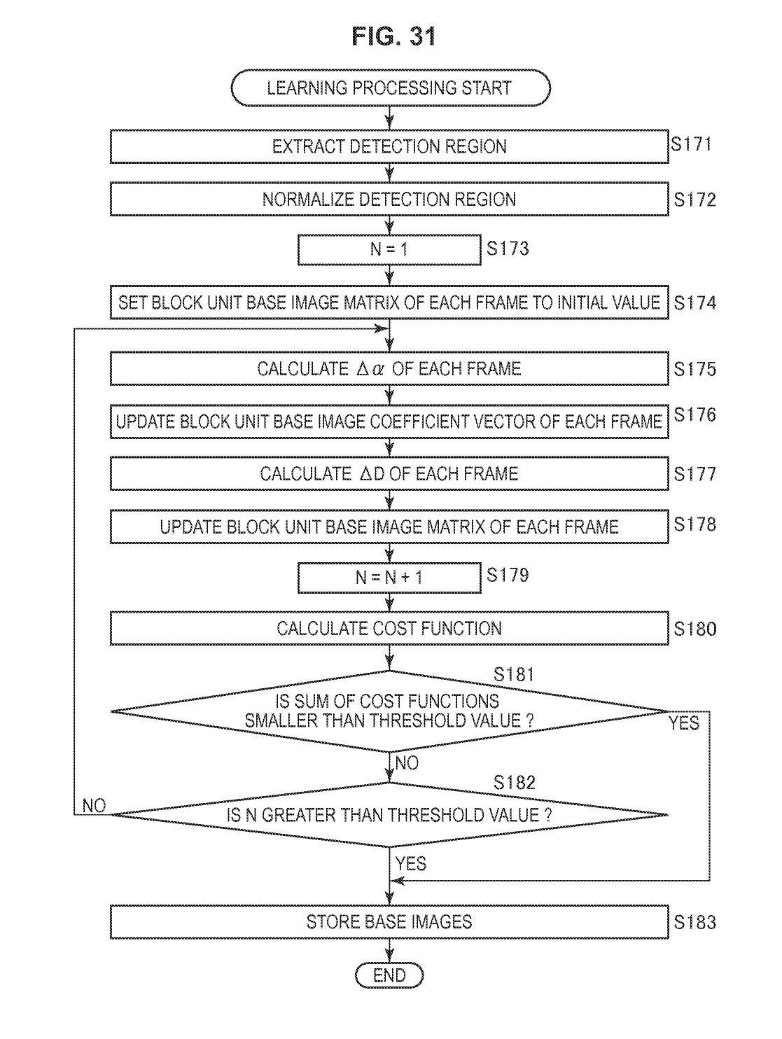

FIG. 31 is a flowchart illustrating learning processing of the learning apparatus 390 of FIG. 30. The learning processing is executed off-line when the moving images of the normal brightness images are input as the moving images of all the learning brightness images from the monitoring camera not illustrated in the drawings to the learning apparatus 390.

In step S171, the extracting unit 391 of the learning apparatus 390 extracts the detection region from each frame of the moving images of all the learning brightness images input from the monitoring camera not illustrated in the drawings.

In step S172, the extracting unit 391 normalizes the extracted detection region, forms the blocks having the predetermined sizes, and supplies the blocks to the learning unit 292. Processing of steps S173 to S183 is the same as the processing of steps S92 to S102 of FIG. 15, except that each color channel changes to each frame of the three continuous frames and the expression defining the cost function is the expression 14, not the expression 12. Therefore, explanation of the processing is omitted.

As described above, the cost function in the learning apparatus 390 includes the term showing the correspondence between the base image coefficients of the individual frames of the three continuous frames as well as the spatial correspondence between the base image coefficients of the three continuous frames, similar to the case of the learning apparatus 290. Therefore, the base image of the detection region can be learned using the model that is optimized for the human visual system and decreases the fluttering between the frames to smooth the moving image. As a result, an accurate base image of a detection region can be learned.

### Configuration Example of Abnormality Detecting Apparatus

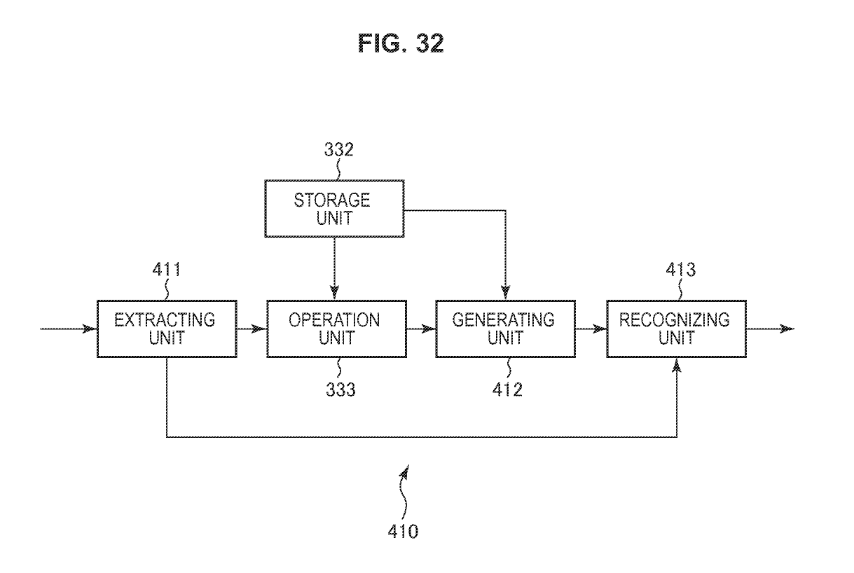

FIG. 32 is a block diagram illustrating a configuration example of an abnormality detecting apparatus that detects abnormality using the base images of the individual frames of the three continuous frames learned by the learning apparatus 390 of FIG. 30 and corresponds to a sixth embodiment of the output apparatus to which the present disclosure is applied.

Among structural elements illustrated in FIG. 32, the structural elements that are the same as the structural elements of FIG. 27 are denoted with the same reference numerals. Repeated explanation of these structural elements is omitted.

A configuration of an abnormality detecting apparatus 410 of FIG. 32 is different from the configuration of FIG. 27 in that an extracting unit 411 is provided, instead of the dividing unit 331, a generating unit 412 is provided, instead of the generating unit 334, and a recognizing unit 413 is newly provided. The abnormality detecting apparatus 410 performs sparse coding with respect to a moving image of a brightness image input as an image of an abnormality detection object from the monitoring camera and detects abnormality.

Specifically, the moving image of the brightness image is input as the image of the abnormality detection object from the monitoring camera to the extracting unit 411 of the abnormality detecting apparatus 410. The extracting unit 411 extracts a detection region from each frame of the image of the abnormality detection object input from the monitoring camera, similar to the extracting unit 391 of FIG. 30.

The extracting unit 411 normalizes the extracted detection region, forms blocks having predetermined sizes, and supplies the blocks to the operation unit 333 and the recognizing unit 413, similar to the extracting unit 391 of FIG. 30. In this case, Y of the expression 14 that defines the cost function in the operation unit 333 of the abnormality detecting apparatus 410 denotes a vector (hereinafter, referred to as a detection image vector) in which pixel values of individual pixels of the blocks of the image of the abnormality detection object are arranged in a column direction.

The generating unit 412 reads the base image of the block unit of each frame of the three continuous frames from the storage unit 332, similar to the generating unit 334 of FIG. 27. The generating unit 412 generates a moving image of a brightness image for each block of each frame of the three continuous frames and supplies the moving image to the recognizing unit 413, similar to the generating unit 334.

The recognizing unit 413 calculates a difference of the moving image of the brightness image of the block unit supplied from the generating unit 412 and the block supplied from the extracting unit 411, for each block of each frame. The recognizing unit 413 detects (recognizes) abnormality of the block on the basis of the difference, generates abnormality information showing whether the abnormality exists, and outputs the abnormality information.

### Example of Detection Region

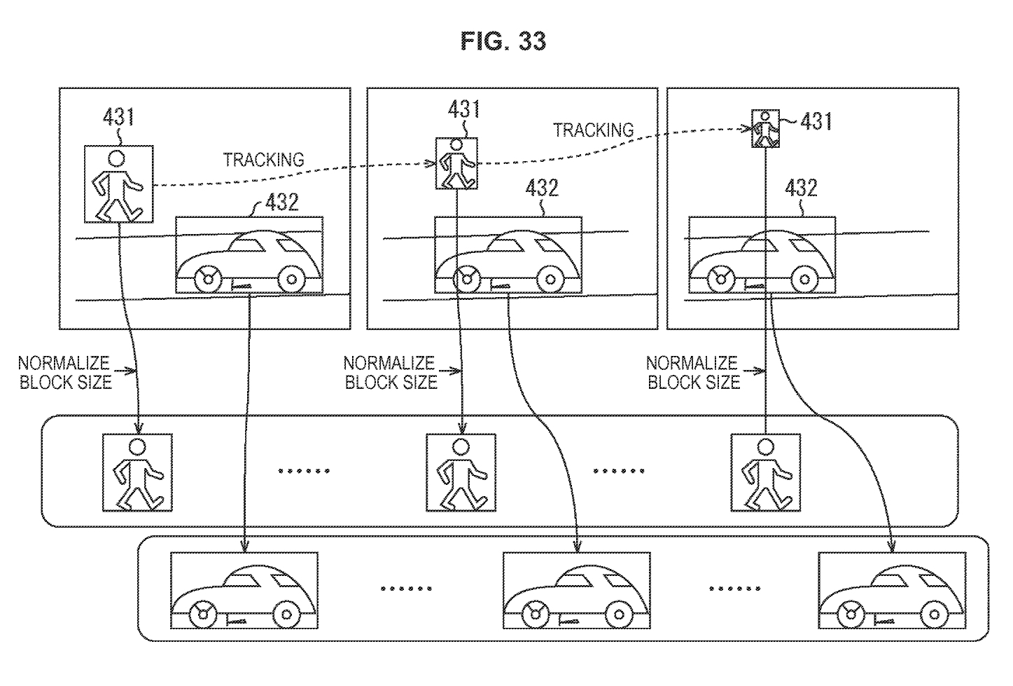

FIG. 33 is a diagram illustrating an example of a detection region that is extracted by the extracting unit 411 of FIG. 32.

In the example of FIG. 33, the extracting unit 411 extracts a region of a person as a detection region 431 and extracts a region of a vehicle as a detection region 432, from each frame of an image of an abnormality detection object. As illustrated in FIG. 33, because sizes of the detection regions 431 and 432 of each frame of the image of the abnormality detection object may be different from each other, the detection regions are normalized by blocks having predetermined sizes.

The number of detection regions of each frame that is extracted by the extracting unit 411 may be plural as illustrated in FIG. 33 or may be singular. When the number of detection regions of each frame is plural, a block unit base image coefficient vector is operated for each detection region and abnormality information is generated.

### [Explanation of Method of Generating Abnormality Information]

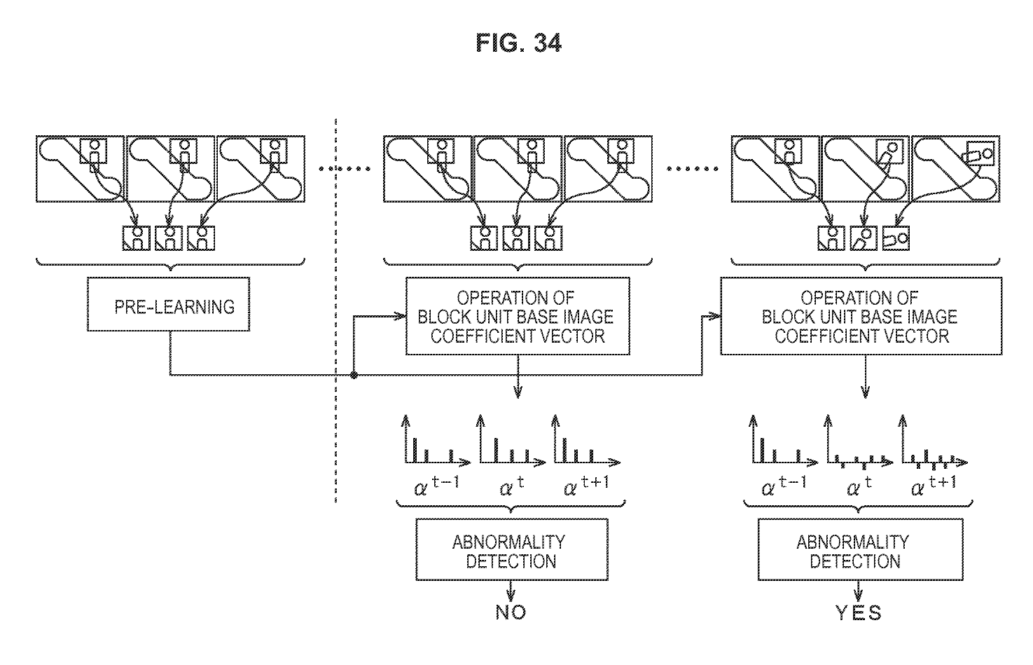

FIG. 34 is a diagram illustrating a method of generating abnormality information by the recognizing unit 413 of FIG. 32.

As illustrated at the left side of FIG. 34, the learning apparatus 390 of FIG. 30 learns a base image of a block unit using moving images of a large amount of normal brightness images. As illustrated at the center and the right side of FIG. 34, the operation unit 333 of the abnormality detecting apparatus 410 of FIG. 32 operates a block unit base image coefficient vector of each frame repetitively by a predetermined number of times, for every three continuous frames, using the learned base image of the block unit and the block of the detection region of the image of the abnormality detection object.

The generating unit 412 generates a moving image of a brightness image of a block unit from the block unit base image coefficient vector of each frame and the base image of the block unit, for every three continuous frames. The recognizing unit 413 operates a difference of the generated moving image of the brightness image of the block unit and the block of the detection region of the image of the abnormality detection object, for each block of each frame.

When a sum of differences of the (t−1)-th frame to the (t+1)-th frame from a head is smaller than a threshold value, as illustrated at the center of FIG. 34, the recognizing unit 413 does not detect abnormality with respect to the frames and generates abnormality information showing that there is no abnormality. Meanwhile, when the sum of the differences of the (t−1)-th frame to the (t+1)-th frame from the head is equal to or greater than the threshold value, as illustrated at the right side of FIG. 34, the recognizing unit 413 detects abnormality with respect to the frames and generates abnormality information showing that there is abnormality.

That is, when the image of the abnormality detection object is the same moving image of the brightness image as the moving image of the learning brightness image, that is, the moving image of the normal brightness image, if an operation of the block unit base image coefficient vector is repeated by the predetermined number of times, the block unit base image coefficient vector is sufficiently converged. Therefore, the difference of the moving image of the brightness image of the block unit generated using the block unit base image coefficient vector and the block of the detection region of the image of the abnormality detection object decreases.

Meanwhile, when the brightness image of the abnormality detection object is not the same moving image of the brightness image as the moving image of the learning brightness image, that is, the brightness image is a moving image of an abnormal brightness image, the block unit base image coefficient vector is not sufficiently converged even though the operation of the block unit base image coefficient vector is repeated by the predetermined number of times. Therefore, the difference of the moving image of the brightness image of the block unit generated using the block unit base image coefficient vector and the block of the detection region of the image of the abnormality detection object increases.

As a result, when the difference of the moving image of the brightness image of the block unit generated using the block unit base image coefficient vector and the block of the detection region of the image of the abnormality detection object is smaller than the threshold value, the recognizing unit 413 does not detect abnormality and generates abnormality information showing that there is no abnormality. When the difference is equal to or greater than the threshold value, the recognizing unit 413 detects abnormality and generates abnormality information showing that there is abnormality.

### [Explanation of Processing of Abnormality Detecting Apparatus]

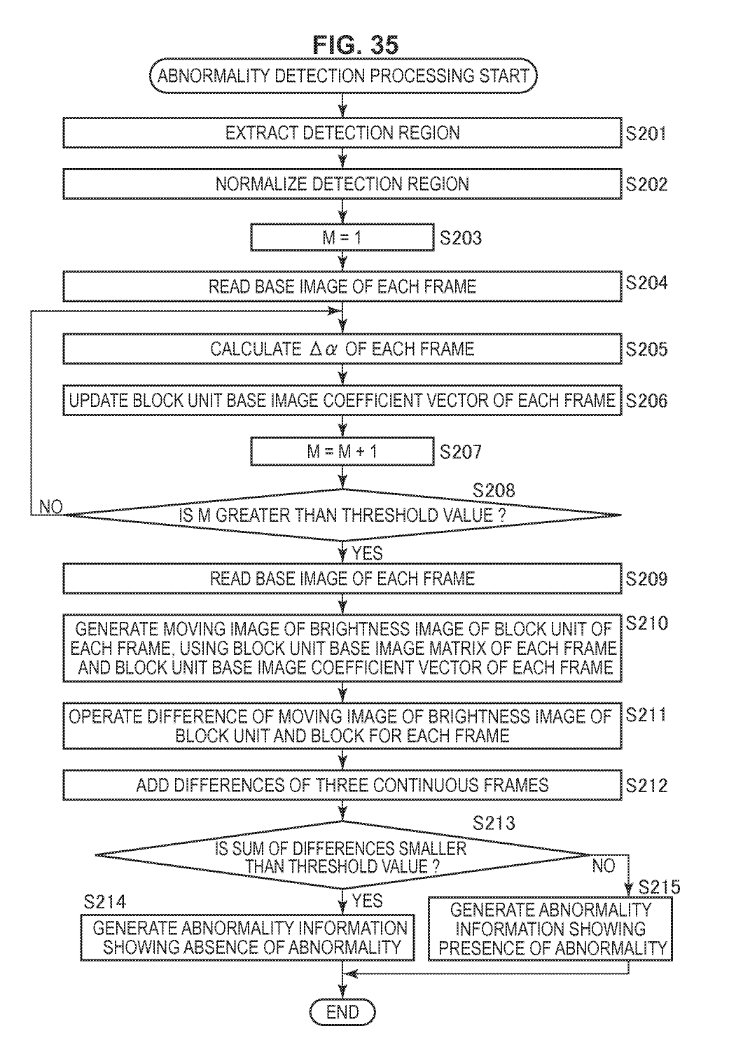

FIG. 35 is a flowchart illustrating abnormality detection processing of the abnormality detecting apparatus 410 of FIG. 32. The abnormality detection processing starts when the three continuous frames of the moving image of the brightness image are input as the image of the abnormality detection object from the monitoring camera.

In step S201 of FIG. 35, the extracting unit 411 of the abnormality detecting apparatus 410 extracts a detection region from each frame of the three continuous frames of the image of the abnormality detection object input from the monitoring camera not illustrated in the drawings, similar to the extracting unit 391 of FIG. 30.

In step S202, the extracting unit 411 normalizes the extracted detection region, forms blocks having predetermined sizes, and supplies the blocks to the operation unit 333 and the recognizing unit 413, similar to the extracting unit 391 of FIG. 30. Processing of following steps S203 to S215 is executed in a block unit.

In step S203, the operation unit 333 sets the number of times M of repeating the operation of the block unit base image coefficient vector to 1. In step S204, the operation unit 333 reads a base image of a block unit of each frame of the three continuous frames from the storage unit 332.

In step S205, the operation unit 333 calculates Δα using the block unit base image matrix including the read base image of the block unit of each frame of the three continuous frames and the blocks supplied from the extracting unit 411. Specifically, the operation unit 333 calculates Δα of each frame of the three continuous frames by an expression obtained by partially differentiating the cost function defined by the expression 14 to the block unit base image coefficient vector of each frame of the three continuous frames and setting Y to the detection image vector, using the block unit base image matrix of each frame of the three continuous frames and the blocks.

In step S206, the operation unit 333 updates the block unit base image coefficient vector of each frame by the expression 7, using Δα calculated by step S205. In step S207, the operation unit 333 increments the number of times M of repeating the operation by 1.

In step S208, the operation unit 333 determines whether the number of times M of repeating the operation is greater than the predetermined threshold value. When it is determined in step S208 that the number of times M of repeating the operation is equal to or smaller than the predetermined threshold value, the operation unit 333 returns the processing to step S205. The processing of steps S205 to S208 is repeated until the number of times M of repeating the operation becomes greater than the predetermined threshold value.

Meanwhile, when it is determined in step S208 that the number of times M of repeating the operation is greater than the predetermined threshold value, the operation unit 333 supplies the block unit base image coefficient vector of each frame updated by immediately previous step S206 to the generating unit 412.

In step S209, the generating unit 412 reads the base image of the block unit of each frame of the three continuous frames from the storage unit 332. In step S210, the generating unit 412 generates the moving image of the brightness image of the block unit of each frame by the expression 10, using the block unit base image matrix including the read base image of the block unit of each frame of the three continuous frames and the block unit base image coefficient vector of each frame supplied from the operation unit 333. The generating unit 412 supplies the moving image of the brightness image of the block unit to the recognizing unit 413.

In step S211, the recognizing unit 413 operates a difference of the moving image of the brightness image of the block unit supplied from the generating unit 412 and the block supplied from the extracting unit 411, for each frame.

In step S212, the recognizing unit 413 adds the differences of the three continuous frames operated by step S211. In step S213, the recognizing unit 413 determines whether a sum of the differences obtained as the result of the addition by step S212 is smaller than the predetermined threshold value.

When it is determined in step S213 that the sum of the differences is smaller than the predetermined threshold value, in step S214, the recognizing unit 413 does not detect abnormality, generates abnormality information showing that there is no abnormality, outputs the abnormality information, and ends the processing.

Meanwhile, when it is determined in step S213 that the sum of the differences is equal to or greater than the predetermined threshold value, in step S215, the recognizing unit 413 detects abnormality, generates abnormality information showing that there is abnormality, outputs the abnormality information, and ends the processing.

As described above, the abnormality detecting apparatus 410 obtains the base image learned using the cost function including the term showing the correspondence between the base image coefficients of the individual frames of the three continuous frames as well as the spatial correspondence between the base image coefficients of the three continuous frames, similar to the image generating apparatus 330. In addition, the abnormality detecting apparatus 410 operates the base image coefficients on the basis of the base image, the image of the abnormality detection object, and the cost function.

Therefore, the abnormality detecting apparatus 410 can obtain the base images and the base image coefficients according to the model that is optimized for the human visual system and decreases fluttering between the frames to smooth the moving image. As a result, the abnormality detecting apparatus 410 can generate a smooth and high-definition moving image of a normal brightness image of a detection region in which the fluttering between the frames is decreased, using the obtained base images and base image coefficients.

In addition, the abnormality detecting apparatus 410 detects (recognizes) abnormality on the basis of the difference of the generated high-definition moving image of the normal brightness image of the detection region and the detection region of the image of the abnormality detection object. Therefore, the abnormality can be detected with high precision.

In the sixth embodiment, the base image is learned and the image is generated, under the same restriction condition as the fourth embodiment. However, the base image may be learned and the image may be generated, under the same restriction condition as the first and third embodiments.

When the learning image and the image of the abnormality detection object are the color images, the base image may be learned and the image may be generated, under the same restriction condition as the second embodiment as well as the first, third, and fourth embodiments. The learning image and the image of the abnormality detection object may be the still images.

The sixth embodiment is an example of an application of the sparse coding to recognition technology and the sparse coding can be applied to recognition technologies such as object recognition other than the abnormality detection.

### Seventh Embodiment

### Explanation of Computer to which Present Disclosure is Applied

The series of processing (the learning processing, the generation processing, and the abnormality detection processing) described above can be executed by hardware or can be executed by software. In the case in which the series of processing is executed by the software, a program configuring the software is installed in a computer. In this case, examples of the computer include a computer that is embedded in dedicated hardware and a general-purpose computer that can execute various functions by installing various programs.

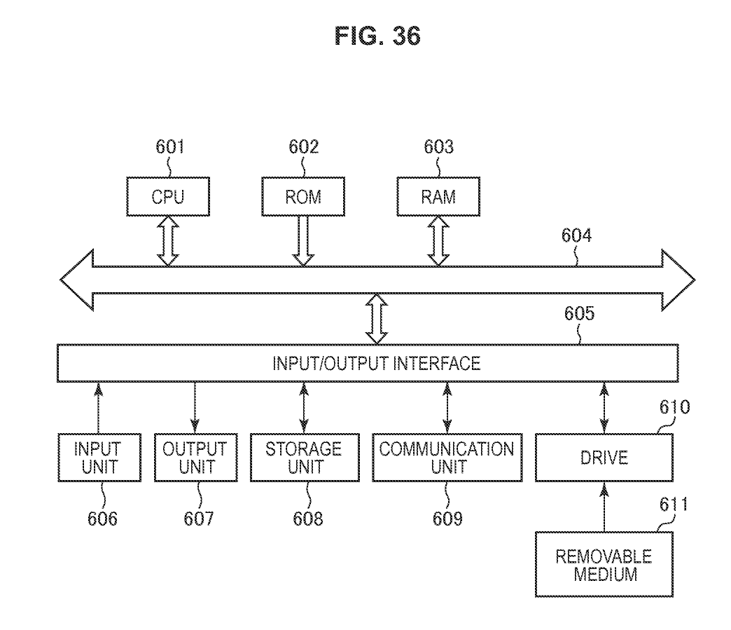

FIG. 36 is a block diagram illustrating a configuration example of hardware of the computer that executes the series of processing by the program.

In the computer, a central processing unit (CPU) 601, a read only memory (ROM) 602, and a random access memory (RAM) 603 are connected mutually by a bus 604.

An input/output interface 605 is connected to the bus 604. An input unit 606, an output unit 607, a storage unit 608, a communication unit 609, and a drive 610 are connected to the input/output interface 605.

The input unit 606 is configured using a keyboard, a mouse, and a microphone. The output unit 607 is configured using a display and a speaker. The storage unit 608 is configured using a hard disk or a nonvolatile memory. The communication unit 609 is configured using a network interface. The drive 610 drives a removable medium 611 such as a magnetic disk, an optical disk, a magneto-optical disk, or a semiconductor memory.

In the computer that is configured as described above, the CPU 601 loads a program stored in the storage unit 608 to the RAM 603 through the input/output interface 605 and the bus 604 and executes the program and the series of processing is executed.

The program that is executed by the computer (CPU 601) can be recorded on the removable medium 611 functioning as a package medium and can be provided. The program can be provided through a wired or wireless transmission medium, such as a local area network, the Internet, and digital satellite broadcasting.

In the computer, the program can be installed in the storage unit 608, through the input/output interface 605, by mounting the removable medium 611 to the drive 610. The program can be received by the communication unit 609 through the wired or wireless transmission medium and can be installed in the storage unit 608. The program can be previously installed in the ROM 602 or the storage unit 608.

The program that is executed by the computer may be a program in which processing is executed in time series according to order described in the present disclosure or a program in which processing is executed in parallel or at necessary timing such as when calling is performed.

It should be understood by those skilled in the art that various modifications, combinations, sub-combinations and alterations may occur depending on design requirements and other factors insofar as they are within the scope of the appended claims or the equivalents thereof.

For example, the present disclosure can take a configuration of cloud computing in which one function is distributed to a plurality of apparatuses through a network and is shared between the plurality apparatuses and processing is executed.

Each step in the flowcharts described above can be executed by one apparatus or can be distributed to a plurality of apparatuses and can be executed by the plurality of apparatuses.

When a plurality of processing is included in one step, the plurality of processing included in one step can be executed by one apparatus or can be distributed to a plurality of apparatuses and can be executed by the plurality of apparatuses.

When the learning signal and the sparse coding object signal are the still images of the color images, the second and third embodiments may be combined. That is, the learning and the sparse coding may be performed using the cost function including the term showing the spatial correspondence between the base image coefficients, the correspondence between the base image coefficients of the individual color channels, and the correspondence between the base image coefficients of the individual bands.

When the learning signal and the sparse coding object signal are the moving images of the brightness images, the third and fourth embodiments may be combined. That is, the learning and the sparse coding may be performed using the cost function including the term showing the spatial correspondence between the base image coefficients, the correspondence between the base image coefficients of the individual bands, and the correspondence between the base image coefficients of the individual frames.

When the learning signal and the sparse coding object signal are the moving images of the color images, at least one of the second and third embodiments and the fourth embodiment may be combined. That is, the learning and the sparse coding may be performed using the cost function including the term showing the spatial correspondence between the base image coefficients, the correspondence between the base image coefficients of at least one of the individual color channels and the individual bands, and the correspondence between the base image coefficients of the individual frames.

Additionally, the present technology may also be configured as below.

(1)
A signal processing apparatus including:

a learning unit that learns a plurality of base signals of which coefficients become sparse, using a cost function including a term showing a correspondence between the coefficients, such that signals are represented by a linear operation of the plurality of base signals.

(2)
The signal processing apparatus according to (1),

wherein the cost function includes a term that shows a spatial correspondence between the coefficients.

(3)
The signal processing apparatus according to (1) or (2),

wherein the cost function includes a term that shows a temporal correspondence between the coefficients.

(4)
The signal processing apparatus according to any one of (1) to (3),

wherein the learning unit learns the plurality of base signals of individual color channels, using the cost function including the term showing the correspondence between the coefficients of the individual color channels, such that the signals of the individual color channels are represented by the linear operation.

(5)
The signal processing apparatus according to any one of (1) to (4), further including:

a band dividing unit that divides bands of the signals and generates the signals of the individual bands.

wherein the learning unit learns the plurality of base signals of the individual bands, using the cost function including the term showing the correspondence between the coefficients of the individual bands, such that the signals of the individual bands generated by the band dividing unit are represented by the linear operation.

(6)
The signal processing apparatus according to any one of (1) to (3),

wherein the learning unit learns the plurality of base signals using the cost function, for each of the color channels, such that the signals of the individual color channels are represented by the linear operation.

(7)
A signal processing method performed by a signal processing apparatus, the signal processing method including:

learning a plurality of base signals of which coefficients become sparse, using a cost function including a term showing a correspondence between the coefficients, such that signals are represented by a linear operation of the plurality of base signals.

(8)
A program for causing a computer to function as a learning unit that learns a plurality of base signals of which coefficients become sparse, using a cost function including a term showing a correspondence between the coefficients, such that signals are represented by a linear operation of the plurality of base signals.
(9)
An output apparatus including:

an operation unit that operates coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.

(10)
The output apparatus according to (9),

wherein the cost function includes a term that shows a spatial correspondence between the coefficients.

(11)
The output apparatus according to (9) or (10).

wherein the cost function includes a term that shows a temporal correspondence between the coefficients.

(12)
The output apparatus according to any one of (9) to (11),

wherein the operation unit operates the coefficients of the predetermined signals of individual color channels, based on the plurality of base signals of the individual color channels learned using the cost function including the term showing the correspondence between the coefficients of the individual color channels, such that the signals of the individual color channels are represented by the linear operation, the predetermined signals of the individual color channels, and the cost function.

(13)
The output apparatus according to any one of (9) to (12), further including:

a band dividing unit that divides bands of the predetermined signals and generates the predetermined signals of the individual bands,

wherein the operation unit operates the coefficients of the predetermined signals of the individual bands, based on the plurality of base signals of the individual bands learned using the cost function including the term showing the correspondence between the coefficients of the individual bands, such that the signals of the individual bands are represented by the linear operation, the predetermined signals of the individual bands generated by the band dividing unit, and the cost function.

(14)
The output apparatus according to any one of (9) to (11),

wherein the operation unit operates the coefficients of the predetermined signals, for each of color channels, based on the plurality of base signals of the individual color channels learned using the cost function, such that the signals of the individual color channels are represented by the linear operation, for each of the color channels, the predetermined signals of the individual color channels, and the cost function.

(15)
The output apparatus according to any one of (9) to (14), further including:

a generating unit that generates signals corresponding to the predetermined signals, using the coefficients operated by the operation unit and the plurality of base signals.

(16)
The output apparatus according to (15), further including:

a recognizing unit that recognizes the predetermined signals, based on differences between the signals generated by the generating unit and the predetermined signals.

(17)
An output method performed by an output apparatus, the output method including:

operating coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.

(18)
A program for causing a computer to function as an operation unit that operates coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.

The present disclosure contains subject matter related to that disclosed in Japanese Priority Patent Application JP 2012-208320 filed in the Japan Patent Office on Sep. 21, 2012, the entire content of which is hereby incorporated by reference.

What is claimed is:

1. A signal processing apparatus comprising:
a learning unit that learns a plurality of base signals of which coefficients become sparse, using a cost function including a term showing a correspondence between the coefficients, such that signals are represented by a linear operation of the plurality of base signals.

2. The signal processing apparatus according to claim 1,
wherein the cost function includes a term that shows a spatial correspondence between the coefficients.

3. The signal processing apparatus according to claim 1,
wherein the cost function includes a term that shows a temporal correspondence between the coefficients.

4. The signal processing apparatus according to claim 1,
wherein the learning unit learns the plurality of base signals of individual color channels, using the cost function including the term showing the correspondence between the coefficients of the individual color channels, such that the signals of the individual color channels are represented by the linear operation.

5. The signal processing apparatus according to claim 1, further comprising:
a band dividing unit that divides bands of the signals and generates the signals of the individual bands,
wherein the learning unit learns the plurality of base signals of the individual bands, using the cost function including the term showing the correspondence between the coefficients of the individual bands, such that the signals of the individual bands generated by the band dividing unit are represented by the linear operation.

6. The signal processing apparatus according to claim 1,
wherein the learning unit learns the plurality of base signals using the cost function, for each of the color channels, such that the signals of the individual color channels are represented by the linear operation.

7. A signal processing method performed by a signal processing apparatus, the signal processing method comprising:
learning a plurality of base signals of which coefficients become sparse, using a cost function including a term showing a correspondence between the coefficients, such that signals are represented by a linear operation of the plurality of base signals.

8. A program for causing a computer to function as a learning unit that learns a plurality of base signals of which coefficients become sparse, using a cost function including a term showing a correspondence between the coefficients, such that signals are represented by a linear operation of the plurality of base signals.

9. An output apparatus comprising:
an operation unit that operates coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.

10. The output apparatus according to claim 9,
wherein the cost function includes a term that shows a spatial correspondence between the coefficients.

11. The output apparatus according to claim 9,
wherein the cost function includes a term that shows a temporal correspondence between the coefficients.

12. The output apparatus according to claim 9,
wherein the operation unit operates the coefficients of the predetermined signals of individual color channels, based on the plurality of base signals of the individual color channels learned using the cost function including the term showing the correspondence between the coefficients of the individual color channels, such that the signals of the individual color channels are represented by the linear operation, the predetermined signals of the individual color channels, and the cost function.

13. The output apparatus according to claim 9, further comprising:
a band dividing unit that divides bands of the predetermined signals and generates the predetermined signals of the individual bands,
wherein the operation unit operates the coefficients of the predetermined signals of the individual bands, based on the plurality of base signals of the individual bands learned using the cost function including the term showing the correspondence between the coefficients of the individual bands, such that the signals of the individual bands are represented by the linear operation, the predetermined signals of the individual bands generated by the band dividing unit, and the cost function.

14. The output apparatus according to claim 9,
wherein the operation unit operates the coefficients of the predetermined signals, for each of color channels, based on the plurality of base signals of the individual color channels learned using the cost function, such that the signals of the individual color channels are represented by the linear operation, for each of the color channels, the predetermined signals of the individual color channels, and the cost function.

15. The output apparatus according to claim 9, further comprising:
a generating unit that generates signals corresponding to the predetermined signals, using the coefficients operated by the operation unit and the plurality of base signals.

16. The output apparatus according to claim 15, further comprising:
a recognizing unit that recognizes the predetermined signals, based on differences between the signals generated by the generating unit and the predetermined signals.

17. An output method performed by an output apparatus, the output method comprising:
operating coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.

18. A program for causing a computer to function as an operation unit that operates coefficients of predetermined signals, based on a plurality of base signals of which the coefficients become sparse, learned using a cost function including a term showing a correspondence between the coefficients, such that signals are represented by a linear operation of the plurality of base signals, the predetermined signals, and the cost function.
